(19) United States
(12) Patent Application Publication
(10) Pub. No.: US 2023/0403641 A1
(43) Pub. Date: Dec. 14, 2023

(54) METHOD AND APPARATUS FOR SUPPORTING A DISCOVERY SIGNAL

(71) Applicant: Samsung Electronics Co., Ltd., Suwon-si (KR)

(72) Inventor: Hongbo Si, Plano, TX (US)

(21) Appl. No.: 18/325,958

(22) Filed: May 30, 2023

Related U.S. Application Data
(60) Provisional application No. 63/351,067, filed on Jun. 10, 2022.
(60) Provisional application No. 63/352,044, filed on Jun. 14, 2022.
(60) Provisional application No. 63/397,713, filed on Aug. 12, 2022.

(51) Int. Cl. H04W 48/16; H04W 56/00; H04B 17/309

(52) U.S. Cl. CPC H04W 48/16; H04W 56/001; H04B 17/309; H04L 5/001

(57) ABSTRACT

Methods and apparatuses for supporting or utilizing a structure of a discovery signal in a wireless communication system. A method of a user equipment (UE) includes receiving a set of configurations for a discovery signal; determining a frequency location of the discovery signal; determining a time domain information of the discovery signal; determining a subcarrier spacing of the discovery signal; and determining a quasi-co-location (QCL) assumption of the discovery signal. The discovery signal includes a primary synchronization signal (PSS) and a secondary synchronization signal (SSS). The method further includes receiving the discovery signal from a secondary cell (SCell) based on the frequency location, the time domain information, the subcarrier spacing, and the QCL assumption of the discovery signal.

### CROSS-REFERENCE TO RELATED AND CLAIM OF PRIORITY

The present application claims priority under 35 U.S.C. § 119(e) to U.S. Provisional Patent Application No. 63/351,067 filed on Jun. 10, 2022; U.S. Provisional Patent Application No. 63/352,044 filed on Jun. 14, 2022; and U.S. Provisional Patent Application No. 63/397,713 filed on Aug. 12, 2022, which is hereby incorporated by reference in its entirety.

### TECHNICAL FIELD

The present disclosure relates generally to wireless communication systems and, more specifically, the present disclosure relates to a structure of a discovery signal.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance. To meet the demand for wireless data traffic having increased since deployment of 4G communication systems, and to enable various vertical applications, 5G communication systems have been developed and are currently being deployed.

### SUMMARY

The present disclosure relates to relates to a structure, sequence design, and procedure of a discovery signal.

In one embodiment, a user equipment (UE) in a wireless communication system is provided. The UE includes a transceiver configured to receive a set of configurations for a discovery signal. The discovery signal includes a primary synchronization signal (PSS) and a secondary synchronization signal (SSS). The UE further includes a processor operably coupled to the transceiver. The processor is configured to determine a frequency location of the discovery signal; determine a time domain information of the discovery signal; determine a subcarrier spacing of the discovery signal; and determine a quasi-co-location (QCL) assumption of the discovery signal. The transceiver is further configured to receive the discovery signal from a secondary cell (SCell) based on the frequency location, the time domain information, the subcarrier spacing, and the QCL assumption of the discovery signal.

In another embodiment, a base station (BS) in a wireless communication system is provided. The BS includes a processor configured to determine a frequency location of a discovery signal; determine a time domain information of the discovery signal; determine a subcarrier spacing of the discovery signal; and determine a QCL assumption of the discovery signal. The BS further includes a transceiver operably coupled to the processor. The transceiver is configured to transmit a set of configurations for the discovery signal and transmit the discovery signal on a SCell based on the frequency location, the time domain information, the subcarrier spacing, and the QCL assumption of the discovery signal. The discovery signal includes a PSS and a SSS.

In yet another embodiment, a method of a UE in a wireless communication system is provided. The method includes receiving a set of configurations for a discovery signal; determining a frequency location of the discovery signal; determining a time domain information of the discovery signal; determining a subcarrier spacing of the discovery signal; and determining a QCL assumption of the discovery signal. The discovery signal includes a PSS and a SSS. The method further includes receiving the discovery signal from a SCell based on the frequency location, the time domain information, the subcarrier spacing, and the QCL assumption of the discovery signal.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIG. 4 illustrates an example of a synchronization signal/physical broadcast channel (SS/PBCH) block structure according to embodiments of the present disclosure;

FIG. 5A illustrates an example of multiplexing of components in a new SS/PBCH block according to embodiments of the present disclosure;

FIG. 5B illustrates an example of multiplexing of components in a new SS/PBCH block according to embodiments of the present disclosure;

FIG. 6A illustrates an example of multiplexing of components in a new SS/PBCH block according to embodiments of the present disclosure;

FIG. 6B illustrates an example of multiplexing of components in a new SS/PBCH block according to embodiments of the present disclosure;

FIG. 7 illustrates an example of a tracking reference signal (TRS) burst according to embodiments of the present disclosure;

FIG. 8 illustrates an example of multiplexing between CSI-RS and new single sideband modulation (SSB) in discovery signal according to embodiments of the present disclosure; and

FIG. 9 illustrates a flowchart of an example UE procedure for receiving a discovery signal according to embodiments of the present disclosure;

FIG. 10 illustrates a flowchart of an example UE procedure for receiving a discovery signal according to embodiments of the present disclosure;

FIG. 11 illustrates a flowchart of an example UE procedure for receiving the discovery signal according to embodiments of the present disclosure; and

FIG. 12 illustrates a flowchart of an example UE procedure for measuring the discovery signal.

### DETAILED DESCRIPTION

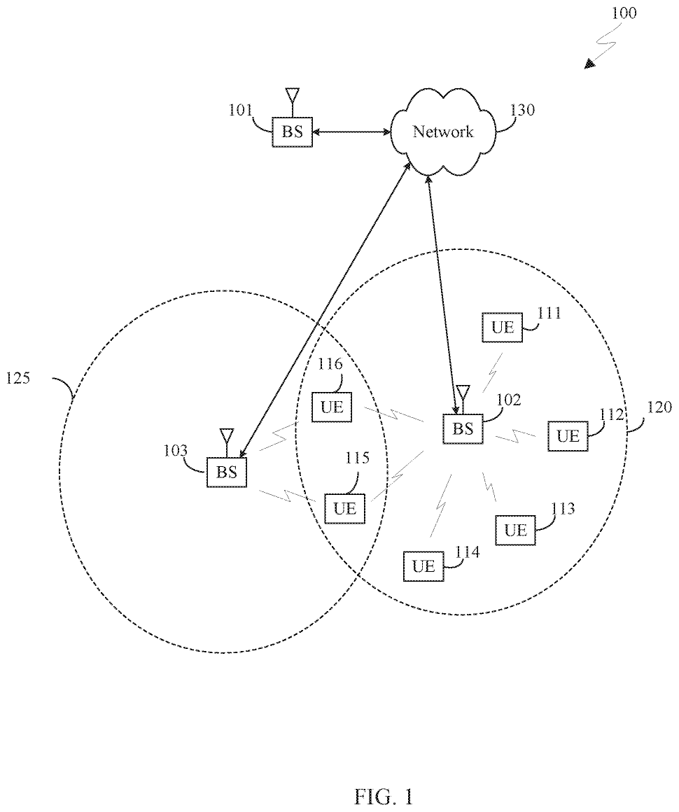

FIGS. 1-12, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents and standards descriptions are hereby incorporated by reference into the present disclosure as if fully set forth herein: [1] 3GPP TS 38.211 v16.1.0, “NR; Physical channels and modulation;” [2] 3GPP TS 38.212 v16.1.0, “NR; Multiplexing and channel coding;” [3] 3GPP TS 38.213 v16.1.0, “NR; Physical layer procedures for control;” [4] 3GPP TS 38.214 v16.1.0, “NR; Physical layer procedures for data;” and [5] 3GPP TS 38.331 v16.1.0, “NR; Radio Resource Control (RRC) protocol specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3 rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

As described in more detail below, one or more of the UEs 111-116 include circuitry, programing, or a combination thereof for supporting or utilizing a structure of a discovery signal. In certain embodiments, one or more of the BS s 101-103 include circuitry, programing, or a combination thereof for supporting or utilizing a structure of a discovery signal.

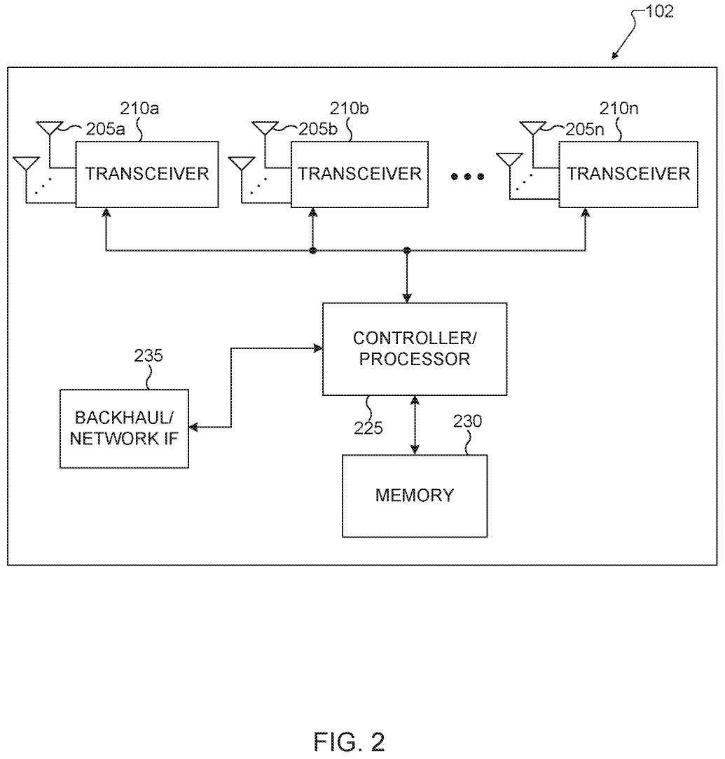

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for supporting or utilizing a structure of a discovery signal. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

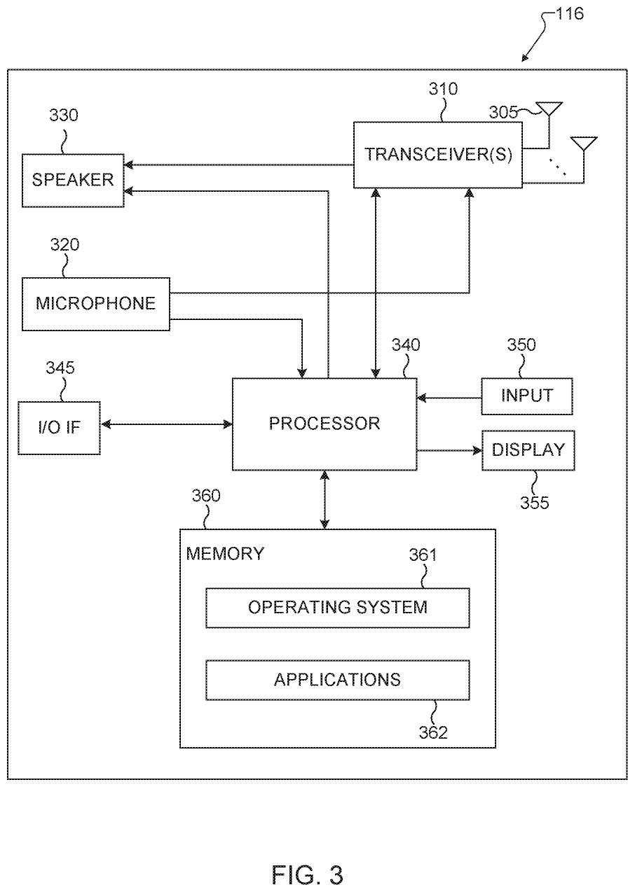

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna(s) 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for supporting or utilizing a structure of a discovery signal as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

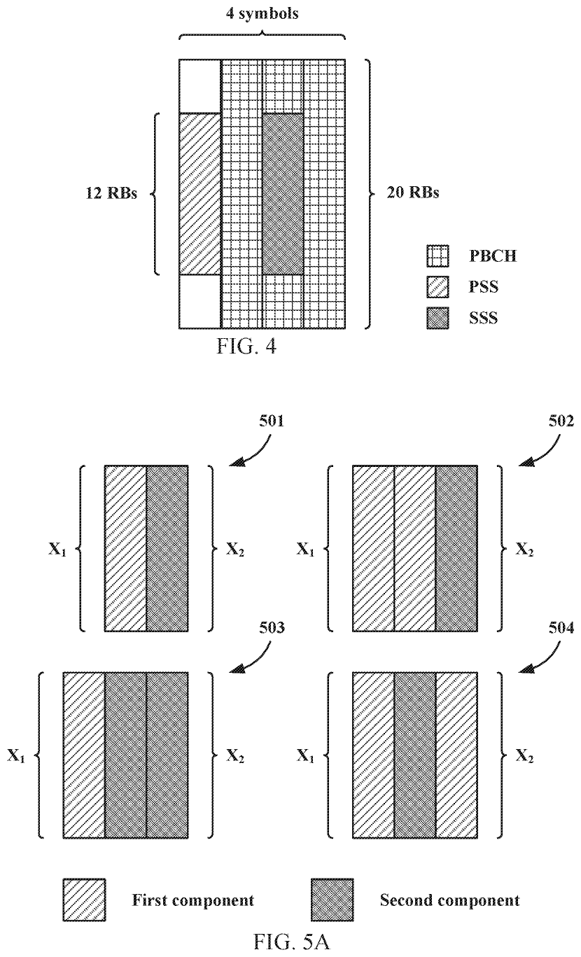

FIG. 4 illustrates an example of a synchronization signal/physical broadcast channel (SS/PBCH) block structure according to embodiments of the present disclosure. The embodiment of the SS/PBCH block structure illustrated in FIG. 4 is for illustration only. FIG. 4 does not limit the scope of this disclosure to any particular implementation of the SS/PBCH block structure.

Embodiments of the present disclosure recognize that new radio (NR) supports synchronization through synchronization signals transmitted on downlink (DL). For example, a synchronization signal/physical broadcast channel (SS/PBCH) block comprises of four consecutive orthogonal frequency division multiplexing (OFDM) symbols in the time domain, e.g. as illustrated in FIG. 4, wherein the first symbol is mapped for primary synchronization signal (PSS), the second and forth symbols are mapped for PBCH, and the third symbol is mapped for both secondary synchronization signal (SSS) and PBCH.

The transmission bandwidth of PSS and SSS, e.g., 12 resource blocks (RBs), is smaller than the transmission bandwidth of the whole SS/PBCH block, e.g., 20 RBs. In every RB mapped for PBCH, 3 out of the 12 resource elements (REs) are mapped for the demodulation reference signal (DMRS) of PBCH, wherein the 3 REs are uniformly distributed in the RB and the starting location of the first RE, e.g., v in the table 1 below, is based on cell ID.

TABLE 1

| Signal or channel | Symbol index | Subcarrier index |
|---|---|---|
| S-PSS | 0 | 56, 57, . . . , 182 |
| S-SSS | 2 | 56, 57, . . . , 182 |
| Set to zero | 0 | 0, 1, . . . , 55, 183, |
| | | 184, . . . , 239 |
| | 2 | 48, 49, . . . , 55, 183, |
| | | 184, . . . , 191 |
| PSBCH | 1, 3 | 0, 1, . . . , 239 |
| | 2 | 0, 1, . . . , 47, 192, |
| | | 193, . . . , 239 |
| DM-RS for PSBCH | 1, 3 | 0 + ν, 4 + ν, . . . , 236 + ν |
| | 2 | 0 + ν, 4 + ν, . . . , 44 + ν, |
| | | 192 + ν, 196 + ν, . . . , 236 + ν, |

SS/PBCH block is transmitted on a cell periodically, with a periodicity configured by a gNB. As an always-present transmission, the power consumption for SS/PBCH block in a cell can be significantly large. To save energy at the gNB side, a simplified design of the SS/PBCH block needs to be considered, and its combination with another signal to facilitate the functionality like synchronization, cell activation, or tracking can be further considered. For these purposes, a discovery signal can be introduced, wherein the discovery signal can be used for at least synchronization, cell activation, or tracking, while keeping low overhead from the gNB transmission perspective. The terminology of discovery signal can be equivalently referred to as discovery burst, discovery reference signal, or discovery signal and channel.

Multiple embodiments of the present disclosure are directed to a structure of a discovery signal. In particular, the discovery signal can include a set of signals that facilitate cell discovery, tracking, or Automatic Gain Control (AGC) purposes. The structure of the discovery signal can include various aspects, such as components included in a discovery signal.

In one aspect, the present disclosure provides a discovery signal that includes a new SS/PBCH block structure. In another aspect, the discovery signal includes only the new SS/PBCH block structure. In another aspect, the discovery signal includes the new SS/PBCH block structure and Channel State Information-Reference Signals (CSI-RS) multiplexed together. The present disclosure also provides an example UE procedure for using the discovery signal.

In one example, a discovery signal can be supported or configured for a SCell. In another example, a discovery signal can be supported or configured for a PSCell.

Embodiments herein relate to the components of a discovery signal. A discovery signal can include a primary synchronization signal (PSS), a secondary synchronization signal (SSS), a de-modulation reference signal (DM-RS) of a physical broadcast channel (PBCH), a PBCH (including its associated DM-RS), and a channel state information reference signal (CSI-RS). The foregoing components are provided by way of example and are not intended to be limiting.

For one example, the CSI-RS can be for tracking. For another example, the CSI-RS can be for layer one reference signal received power (L1-RSRP) and/or layer 1 signal to interference & noise ration (L1-SINR) computation. For yet another example, the CSI-RS can be for mobility.

Upon further consideration of the present embodiment, at least one of the components may be deemed fundamental, leading to their inclusion in every discovery signal. To illustrate, one or more of PSS, SSS, PBCH/demodulation reference signal (DM-RS) of PBCH can serve as the fundamental components.

Another aspect of this embodiment involves configuring at least one component to be included in the discovery signal, which may or may not be included in every discovery signal. For instance, the CSI-RS can be configured as the component.

In another aspect of this embodiment, the components in the discovery signal have the same periodicity, such that all components are included in every discovery signal. As an example, the discovery signal includes a new SS/PBCH block structure only, wherein the new SS/PBCH block structure can include at least one of PSS, SSS, PBCH or the DM-RS of PBCH, as detailed in this disclosure.

In yet another consideration of this embodiment, the components in the discovery signal may not have uniform periodicity, with some components present in every signal and others in only a subset of signals. For instance, some discovery signals may include a new SS/PBCH block structure only, wherein the new SS/PBCH block structure can include at least one of PSS, SSS, PBCH or the DM-RS of PBCH, as disclosed herein. Some discovery signals may include both the new SS/PBCH block structure and CSI-RS, while a third signal may only include CSI-RS. It is also possible that some discovery signal includes the new SS/PBCH block structure and CSI-RS.

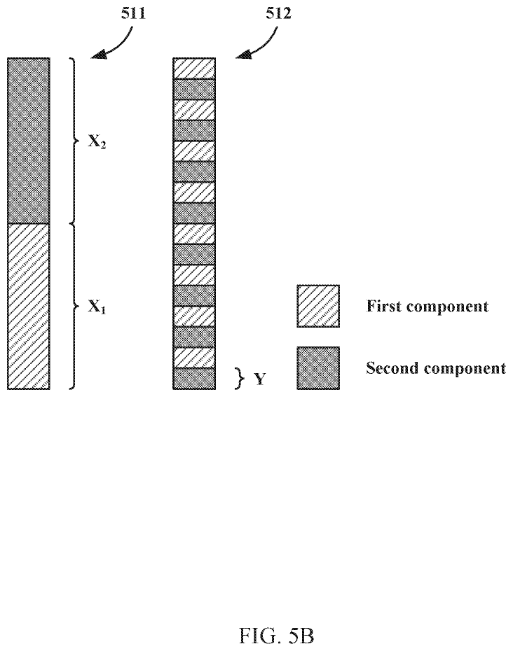

FIG. 5A and FIG. 5B illustrate examples of a new SSB block structure according to embodiments of the present disclosure. In one embodiment, a new SS/PBCH block structure can include at least one of PSS, SSS, PBCH or the DM-RS of PBCH, wherein the at least one of PSS, SSS, PBCH or the DM-RS of PBCH are multiplexed into a block. In one sub-embodiment, the new SS/PBCH block can include two components as described in the present disclosure, wherein the two components are multiplexed according to at least one example in FIG. 5A or FIG. 5B. For example, the new SS/PBCH block structure may be used in network 130 by BS 102. The examples are for illustration only and other embodiments can be used without departing from the scope of the present disclosure.

For example, as illustrated by 501 in FIG. 5A, the new SS/PBCH block includes two consecutive symbols. The first symbol is mapped for the first component, and the second symbol is mapped for the second component, wherein the two symbols are time division multiplexed (TDM). The bandwidth of the first component is X₁ RBs, and the bandwidth of the second component is X₂ RBs.

For another example, as illustrated by 502 in FIG. 5A, the new SS/PBCH block includes three consecutive symbols. The first and second symbols are mapped for the first component, and the third symbol is mapped for the second component, wherein the three symbols are TDMed. The bandwidth of the first component is X₁ RBs, and the bandwidth of the second component is X₂ RBs.

For yet another example, as illustrated by 503 in FIG. 5A, the new SS/PBCH block includes three consecutive symbols. The first symbol is mapped for the first component, and the second and third symbols are mapped for the second component, wherein the three symbols are TDMed. The bandwidth of the first component is X₁ RBs, and the bandwidth of the second component is X₂ RBs.

For another example, as illustrated by 504 in FIG. 5A, the new SS/PBCH block includes three consecutive symbols. The first and third symbols are mapped for the first component, and the second symbol is mapped for the second component, wherein the three symbols are TDMed. The bandwidth of the first component is X₁ RBs, and the bandwidth of the second component is X₂ RBs.

For a further example, as illustrated by 511 in FIG. 5B, the new SS/PBCH block includes one symbol. The first component and the second component are multiplexed in the symbol, e.g., using a FDM pattern. The bandwidth of the first component is X₁ RBs, and the bandwidth of the second component is X₂ RBs.

As a further illustration, by 512 in FIG. 5B, the new SS/PBCH block includes one symbol. The first component and the second component are multiplexed in the symbol, e.g., using an interleaved FDM pattern. The granularity for the interleaved FDM pattern is Y, e.g., Y can be 1 RB, or 1 RE. For instance, the first component in the examples of this sub-embodiment can be PSS, and the second component in the examples of this sub-embodiment can be SSS. For one further consideration of this example, X₁ can be the same as X₂, e.g., X₁=X₂=12 RB.

Additionally, the first component in the examples of this sub-embodiment can be SSS, and the second component in the examples of this sub-embodiment can be PSS. For one further consideration of this example, X₁ can be the same as X₂, e.g., X₁=X₂=12 RB.

Furthermore, the first component in the examples of this sub-embodiment can be PSS, and the second component in the examples of this sub-embodiment can be DM-RS of PBCH. For one further consideration of this example, X₁ can be the same as X₂, e.g., X₁=X₂=12 RB.

Moreover, the first component in the examples of this sub-embodiment can be DM-RS of PBCH, and the second component in the examples of this sub-embodiment can be PSS. For one further consideration of this example, X₁ can be the same as X₂, e.g., X₁=X₂=12 RB.

Also, the first component in the examples of this sub-embodiment can be SSS, and the second component in the examples of this sub-embodiment can be DM-RS of PBCH. For one further consideration of this example, X₁ can be the same as X₂, e.g., X₁=X₂=12 RB.

Additionally, the first component in the examples of this sub-embodiment can be DM-RS of PBCH, and the second component in the examples of this sub-embodiment can be SSS. For one further consideration of this example, X₁ can be the same as X₂, e.g., X₁=X₂=12 RB.

To give another instance, the first component in the examples of this sub-embodiment can be PSS, and the second component in the examples of this sub-embodiment can be PBCH. For one further consideration of this example, X₁ can smaller than X₂, e.g., X₁=12 RB and X₂>12 RB, e.g., 20 or 24 RBs.

As another instance, the first component in the examples of this sub-embodiment can be PBCH, and the second component in the examples of this sub-embodiment can be PSS. For one further consideration of this example, X₁ can be larger than X₂, e.g., X₂=12 RB and X₁>12 RB, e.g., 20 or 24 RBs.

As a further instance, the first component in the examples of this sub-embodiment can be SSS, and the second component in the examples of this sub-embodiment can be PBCH. For one further consideration of this example, X₁ can smaller than X₂, e.g., X₁=12 RB and X₂>12 RB, e.g., 20 or 24 RBs.

In addition to that, the first component in the examples of this sub-embodiment can be PBCH, and the second component in the examples of this sub-embodiment can be SSS. For one further consideration of this example, X₁ can be larger than X₂, e.g., X₂=12 RB and X₁>12 RB, e.g., 20 or 24 RBs.

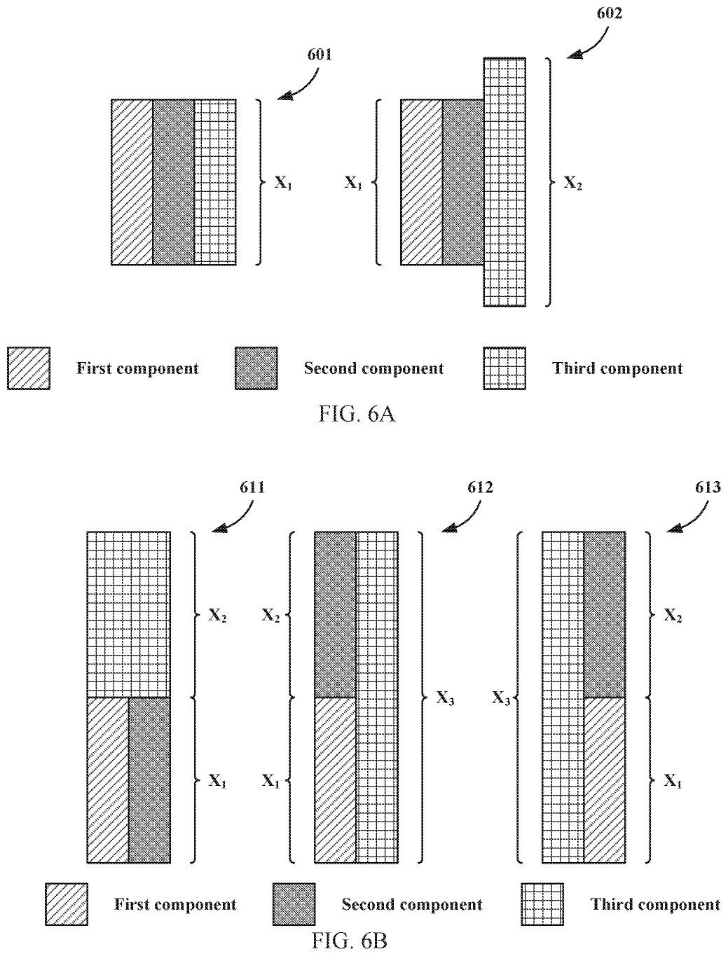

FIG. 6A and FIG. 6B illustrate an example of another sub-embodiment according to embodiments of the present disclosure. For example, the new SS/PBCH block can include three components, wherein the three components are multiplexed according to at least one example in FIG. 6A or FIG. 6B. For example, the new SS/PBCH block may be used in network 130 by BS 102. This example is for illustration only and other embodiments can be used without departing from the scope of the present disclosure.

For one example, as illustrated by 601 in FIG. 6A, the new SS/PBCH block includes three consecutive symbols. The first symbol is mapped for the first component, the second symbol is mapped for the second component, and the third symbol is mapped for the third component, wherein the three symbols are TDMed. For one further consideration, the bandwidth of all the components is the same.

For another example, as illustrated by 602 in FIG. 6A, the new SS/PBCH block includes three consecutive symbols. The first symbol is mapped for the first component, the second symbol is mapped for the second component, and the third symbol is mapped for the third component, wherein the three symbols are TDMed. For one further consideration, the bandwidth of all the components may not be the same, e.g., the first and second symbols have bandwidth as X₁ RBs and the third symbol has bandwidth as X₂ RBs.

For yet another example, as illustrated by 611, 612, and 613 in FIG. 6B, the components in the new SS/PBCH block can be multiplexed using a mixture of time division multiplexing (TDM) and frequency division multiplexing (FDM) patterns.

For one instance, the first component in the examples of this sub-embodiment can be PSS, the second component in the example can be SSS, and the third component in the example can be DM-RS of PBCH. For one further consideration, X₁=12 RB for all the symbols in the example.

For another instance, the first component in the examples of this sub-embodiment can be PSS, the second component in the example can be DM-RS of PBCH, and the third component in the example can be SSS. For one further consideration, X₁=12 RB for all the symbols in the example.

For a third instance, the first component in the examples of this sub-embodiment can be SSS, the second component in the example can be DM-RS of PBCH, and the third component in the example can be PSS. For one further consideration, X₁=12 RB for all the symbols in the example.

For a fourth instance, the first component in the examples of this sub-embodiment can be SSS, the second component in the example can be PSS, and the third component in the example can be DM-RS of PBCH. For one further consideration, X₁=12 RB for all the symbols in the example.

For a fifth instance, the first component in the examples of this sub-embodiment can be DM-RS of PBCH, the second component in the example can be PSS, and the third component in the example can be SSS. For one further consideration, X₁=12 RB for all the symbols in the example.

For a further instance, the first component in the examples of this sub-embodiment can be DM-RS of PBCH, the second component in the example can be SSS, and the third component in the example can be PSS. For one further consideration, X₁=12 RB for all the symbols in the example.

To give another instance, the first component in the examples of this sub-embodiment can be PSS, the second component in the example can be SSS, and the third component in the example can be PBCH. For one further consideration, X₁=12 RB, and X₂>X₁ (X₂=20 or 24 RB).

As an additional instance, the first component in the examples of this sub-embodiment can be SSS, the second component in the example can be PSS, and the third component in the example can be PBCH. For one further consideration, X₁=12 RB, and X₂>X₁ (X₂=20 or 24 RB).

In one embodiment, a discovery signal can include the new SS/PBCH block only. In this sense, the structure of the discovery signal is the same as the new SS/PBCH block structure, wherein the new SS/PBCH block structure is according to an example in this disclosure. For example, the discovery signal including only a new SSB can be used in network 130 by BS 102. This example is for illustration only and other embodiments can be used without departing from the scope of the present disclosure.

In another example, the new SS/PBCH block can be mapped into slot(s) in a half frame based on a fixed pattern, in terms of the starting symbol index(es) of the new SS/PBCH block. For instance, the fixed pattern for the starting symbol index of the new SS/PBCH block can be according to table 2 below, wherein d is the number of symbols in the new SS/PBCH block, the symbol index starts from 0 corresponding to the first symbol of the first slot in the half frame, and n is an integer starting from 0 and till the maximum number of candidate SS/PBCH blocks in a half frame is achieved.

TABLE 2

| Example # | d | Starting symbol index(es) |
|---|---|---|
| 1 | 2 | {0, 2, 4, 6, 8, 10, 12} + 14 · n |
| 2 | 3 | {0, 3, 6, 9, 12, 15, 18, 21, 24, |
| | | 27, 30, 33, 36, 39} + 42 · n |
| 3 | 3 | {2, 5, 8, 11} + 14 · n |

In another example, the new SS/PBCH block can be mapped into a slot based on a configuration from a higher layer. For one instance, the configuration includes at least one starting symbol index(es) in the slot. For another instance, the configuration includes an index of a mapping pattern, from a set of pre-defined or pre-configured mapping patterns.

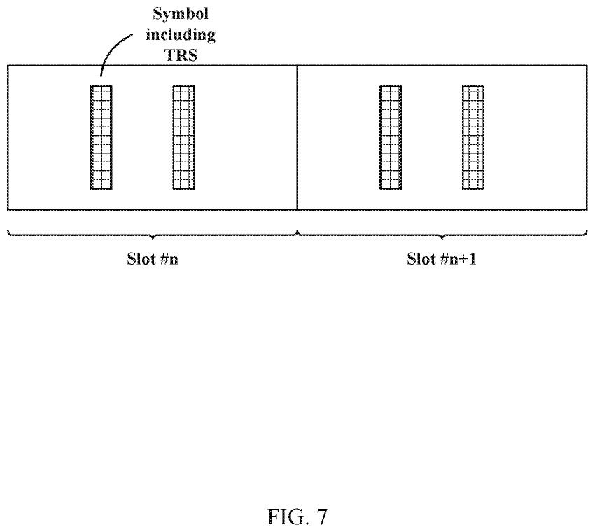

FIG. 7 illustrates an example of a tracking reference signal (TRS) burst according to embodiments of the present disclosure. In one embodiment, a discovery signal can include the new SS/PBCH block and CSI-RS, wherein the CSI-RS and the new SS/PBCH block are multiplexed. This example is for illustration only and other embodiments can be used without departing from the scope of the present disclosure.

In one further consideration, the CSI-RS included in the discovery signal can be a CSI-RS for tracking, e.g., a tracking reference signal (TRS). As illustrated in FIG. 7, the resources for TRS are mapped into a TRS burst, wherein a TRS burst includes two consecutive slots and each slot has two symbols mapped for TRS. The symbol index(es) of the two symbols is provided by a higher layer parameter.

In one example, when the new SS/PBCH block is multiplexed with the CSI-RS in the discovery signal, the new SS/PBCH block is included in one of the two slots in the TRS burst. For one instance, the new SS/PBCH block is included in the first slot within the two slots in the TRS burst. For another instance, the new SS/PBCH block is included in the second slot within the two slots in the TRS burst. For yet another instance, a higher layer parameter can provide an indication of which one of the two slots includes the new SS/PBCH block.

In another example, when the new SS/PBCH block is multiplexed with the CSI-RS in the discovery signal, the new SS/PBCH block is included in both of the two slots in the TRS burst.

In yet another example, when the new SS/PBCH block is multiplexed with the CSI-RS in the discovery signal, a higher layer parameter can provide an indication of which one or two of the two slots includes the new SS/PBCH block. For instance, the indication can use a bitmap, wherein each bit corresponds to a slot in the TRS burst, and the bit taking value of 1 means that the corresponding slot includes the new SS/PBCH block.

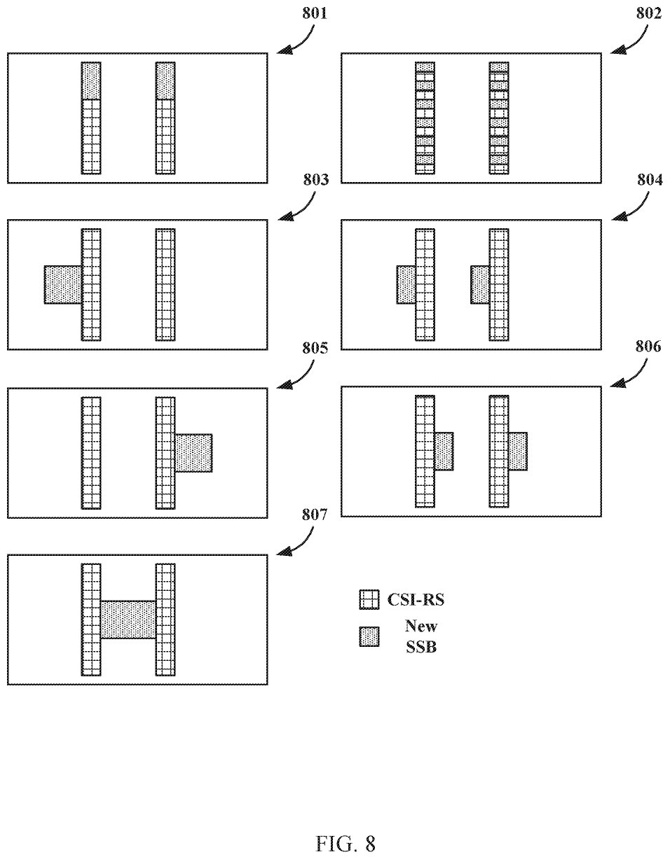

FIG. 8 illustrates an example of multiplexing between CSI-RS and new SSB in discovery signal according to embodiments of the present disclosure. In one embodiment, a discovery signal can include the new SS/PBCH block and CSI-RS, wherein the CSI-RS and the new SS/PBCH block are multiplexed. This example is for illustration only and other embodiments can be used without departing from the scope of the present disclosure.

In one embodiment, for a slot including both the new SS/PBCH block and CSI-RS, the new SS/PBCH block and the CSI-RS can be multiplexed in the slot according to at least one of the following examples. In one example, 801 in FIG. 8, the new SS/PBCH block can be FDMed with the CSI-RS. For instance, the first symbol in the new SS/PBCH block can be FDMed with the first symbol of CSI-RS in the slot, and the second symbol in the new SS/PBCH block can be FDMed with the second symbol of CSI-RS in the slot.

In another example, 802 in FIG. 8, resources in the new SS/PBCH block can be interleaved and FDMed with resources of the CSI-RS. For instance, resources in the first symbol in the new SS/PBCH block can be interleaved and FDMed with resources in the first symbol of CSI-RS in the slot, and resources in the second symbol in the new SS/PBCH block can be interleaved and FDMed with resources in the second symbol of CSI-RS in the slot. For one further consideration, the granularity for the resources to be interleaved can be a RB. For another further consideration, the granularity for the resources to be interleaved can be a RE. For one further consideration, the interleaving and multiplexing can be based on k₁ resources, RB/RE, from the new SS/PBCH block and k₂ resources, RB/RE, from the CSI-RS, e.g., k₁=k₂=1. For example, the new SS/PBCH block interleaved and FDMed with resources of the CSI-RS can be used in network 130 by BS 102.

In yet another example, 803 in FIG. 8, the new SS/PBCH block can be TDMed with the CSI-RS. For one instance, the whole new SS/PBCH block can be located before the first symbol of CSI-RS in the slot, and there is no time domain gap between the new SS/PBCH block and the first symbol of CSI-RS in the slot, e.g., the starting symbol for the new SS/PBCH block is l₁−d, where l₁ is the symbol index of the first symbol of the CSI-RS, and d is the duration (e.g., the number of symbols) of the new SS/PBCH block. For another instance, the whole new SS/PBCH block can be located before the first symbol of CSI-RS in the slot, and there is a time domain gap between the new SS/PBCH block and the first symbol of CSI-RS in the slot, e.g., the starting symbol for the new SS/PBCH block is l₁−d-g, where l₁ is the symbol index of the first symbol of the CSI-RS, d is the duration, e.g., the number of symbols, of the new SS/PBCH block, and g is the duration, e.g., the number of symbols, of the time domain gap, e.g., a fixed gap. For one further consideration of this example, the relative frequency domain location between the new SS/PBCH block and the CSI-RS can be fixed, e.g., the center of the new SS/PBCH block is aligned with the center of the CSI-RS, or the lowest RE of the new SS/PBCH block is aligned with the lowest RE of the CSI-RS, or the highest RE of the new SS/PBCH block is aligned with the highest RE of the CSI-RS. For another further consideration of this example, the relative frequency domain location between the new SS/PBCH block and the CSI-RS can be based on indications, e.g., a first indication of the frequency location of the new SS/PBCH block and a second indication of the frequency location of the CSI-RS.

In yet another example, 804 in FIG. 8, the new SS/PBCH block can be divided into two parts, e.g., the first part has 1 symbol and the second part has 1 symbol, and each part is TDMed with one of the symbols for the CSI-RS. For one instance, the first part of the new SS/PBCH block can be located before the first symbol of CSI-RS in the slot, and the second part of the new SS/PBCH block can be located before the second symbol of CSI-RS in the slot. For one further consideration of this example, the relative frequency domain location between the new SS/PBCH block and the CSI-RS can be fixed, e.g., the center of the new SS/PBCH block is aligned with the center of the CSI-RS, or the lowest RE of the new SS/PBCH block is aligned with the lowest RE of the CSI-RS, or the highest RE of the new SS/PBCH block is aligned with the highest RE of the CSI-RS. For another further consideration of this example, the relative frequency domain location between the new SS/PBCH block and the CSI-RS can be based on indications, e.g., a first indication of the frequency location of the new SS/PBCH block and a second indication of the frequency location of the CSI-RS.

In yet another example, 805 in FIG. 8, the new SS/PBCH block can be TDMed with the CSI-RS. For one instance, the whole new SS/PBCH block can be located after the second symbol of CSI-RS in the slot, and there is no time domain gap between the new SS/PBCH block and the second symbol of CSI-RS in the slot, e.g., the starting symbol for the new SS/PBCH block is l₂+1, where l₂ is the symbol index of the second symbol of the CSI-RS. For another instance, the whole new SS/PBCH block can be located after the second symbol of CSI-RS in the slot, and there is a time domain gap between the new SS/PBCH block and the second symbol of CSI-RS in the slot, e.g., the starting symbol for the new SS/PBCH block is l₂+g+1, where l₂ is the symbol index of the second symbol of the CSI-RS, and g is the duration, e.g., the number of symbols, of the time domain gap, e.g., a fixed gap. For one further consideration of this example, the relative frequency domain location between the new SS/PBCH block and the CSI-RS can be fixed, e.g., the center of the new SS/PBCH block is aligned with the center of the CSI-RS, or the lowest RE of the new SS/PBCH block is aligned with the lowest RE of the CSI-RS, or the highest RE of the new SS/PBCH block is aligned with the highest RE of the CSI-RS. For another further consideration of this example, the relative frequency domain location between the new SS/PBCH block and the CSI-RS can be based on indications, e.g., a first indication of the frequency location of the new SS/PBCH block and a second indication of the frequency location of the CSI-RS.

In yet another example, 806 in FIG. 8, the new SS/PBCH block can be divided into two parts, e.g., the first part has 1 symbol and the second part has 1 symbol, and each part is TDMed with one of the symbols for the CSI-RS. For one instance, the first part of the new SS/PBCH block can be located after the second symbol of CSI-RS in the slot, and the second part of the new SS/PBCH block can be located after the second symbol of CSI-RS in the slot. For one further consideration of this example, the relative frequency domain location between the new SS/PBCH block and the CSI-RS can be fixed, e.g., the center of the new SS/PBCH block is aligned with the center of the CSI-RS, or the lowest RE of the new SS/PBCH block is aligned with the lowest RE of the CSI-RS, or the highest RE of the new SS/PBCH block is aligned with the highest RE of the CSI-RS. For another further consideration of this example, the relative frequency domain location between the new SS/PBCH block and the CSI-RS can be based on indications, e.g., a first indication of the frequency location of the new SS/PBCH block and a second indication of the frequency location of the CSI-RS.

In yet another example, 807 in FIG. 8, the new SS/PBCH block can be TDMed with the CSI-RS. For one instance, the whole new SS/PBCH block can be located between the first symbol and the second symbol of CSI-RS in the slot, e.g., the starting symbol for the new SS/PBCH block is l₁+1, where l₁ is the symbol index of the first symbol of the CSI-RS, or the starting symbol for the new SS/PBCH block is l₂−d, where l₂ is the symbol index of the second symbol of the CSI-RS, and d is the duration, e.g., the number of symbols, of the new SS/PBCH block. For one further consideration of this example, the relative frequency domain location between the new SS/PBCH block and the CSI-RS can be fixed, e.g., the center of the new SS/PBCH block is aligned with the center of the CSI-RS, or the lowest RE of the new SS/PBCH block is aligned with the lowest RE of the CSI-RS, or the highest RE of the new SS/PBCH block is aligned with the highest RE of the CSI-RS. For another further consideration of this example, the relative frequency domain location between the new SS/PBCH block and the CSI-RS can be based on indications, e.g., a first indication of the frequency location of the new SS/PBCH block and a second indication of the frequency location of the CSI-RS.

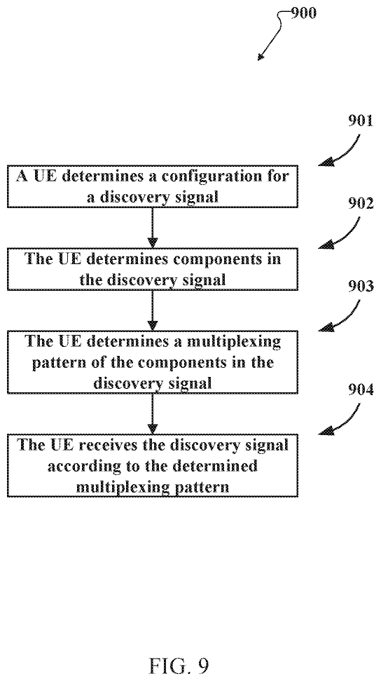

FIG. 9 illustrates a flowchart of an example UE procedure 900 for receiving the discovery signal according to various embodiments of the present disclosure. For example, the example UE procedure 900 may be performed by the UE 116. The procedure 900 is for illustration only and other embodiments can be used without departing from the scope of the present disclosure.

The UE 116 determines a configuration for a discovery signal in step 901. The UE 116 then determines components in the discovery signal based on the configuration in step 902. The UE 116 determines a multiplexing pattern of the components in the discovery signal in step 903 and receives the discovery signal according to the multiplexing pattern in step 904.

Multiple embodiments of the present disclosure are directed to the sequence design of signals in the discovery signal. The discovery signal can include aspects, such as a PSS sequence design. In one aspect, the present disclosure provides a SSS sequence design. In another aspect, the discovery signal includes a DM-RS sequence design. The present disclosure also provides an example UE procedure for using the discovery signal.

In one example, the discovery signal can be supported or configured for a SCell. In another example, the discovery signal can be supported or configured for a PSCell.

In another example, a discovery signal can include at least one PSS, a SSS, or a de-modulation reference signal (DM-RS) of a physical broadcast channel (PBCH) or a PBCH (including its associated DM-RS). For one further consideration, the at least one of a PSS, SSS, or a DM-RS of PBCH or a PBCH (including its associated DM-RS) can be multiplexed into a block, e.g., denoted as a new SS/PBCH block, which can be included or equivalent to the discovery first.

Embodiments herein relate to a first component, PSS sequence design. In one embodiment, the sequence for PSS in the new SS/PBCH block can be different from the sequence for PSS in the legacy SS/PBCH block.

For one further consideration, the sequence for PSS in the new SS/PBCH block can be orthogonal or with low cross-correlation with the sequence for PSS in the legacy SS/PBCH block, e.g., such that the new SS/PBCH block may not have much impact to the PSS detection performance for the legacy SS/PBCH block.

For another further consideration, the sequence for PSS in the new SS/PBCH block can be based on length-127 M-sequence, e.g., d_{PSS}^{new}(n)=1−2·x(m), where 0≤n<127. In the following examples, N_{ID}⁽²⁾ is part of the physical cell ID, e.g., N_{ID}^{cell}=3·N_{ID}⁽¹⁾+N_{ID}⁽²⁾, and N_{ID}^{cell} is the physical cell ID. For one example, the sequence for PSS in the new SS/PBCH block has the same generating function and initial condition as the sequence for PSS in the legacy SS/PBCH block, but with a different cyclic shift, e.g.,

x(i+7)=(x(i+4)+x(i))mod 2, where 0≤i<120,

[x(6)x(5)x(4)x(3)x(2)x(1)x(0)]=[1 1 1 0 1 1 0], and

m=(n+Δ+43·N_{ID}⁽²⁾)mod 127.

In one instance of this example, Δ is a fixed number as 21. In another instance of this example, Δ is a fixed number as 22. In yet another instance of this example, Δ is a fixed number as 11. In yet another instance of this example, Δ is a fixed number as 10. In yet another instance of this example, Δ can be provided by the gNB using a higher layer parameter.

For another example, the sequence for PSS in the new SS/PBCH block has the same generating function and cyclic shift as the sequence for PSS in the legacy SS/PBCH block, but with a different initial condition, e.g.,

x(i+7)=(x(i+4)+x(0)mod 2, where 0≤i<120,

m=(n+43·N_{ID}⁽²⁾)mod 127, and

[x(6)x(5)x(4)x(3)x(2)x(1)x(0)]≠[1 1 1 0 1 1 0].

For yet another example, the sequence for PSS in the new SS/PBCH block has the same initial condition and cyclic shift as the sequence for PSS in the legacy SS/PBCH block, but with a different generating function, e.g.,

m=(n+43·N_{ID}⁽²⁾)mod 127,

[x(6)x(5)x(4)x(3)x(2)x(1)x(0)]=[1 1 1 0 1 1 0],

and the generation function of the sequence for PSS in the new SS/PBCH block is based on one of the examples in the table 3 below.

TABLE 3

| Example # | Generation function |
|---|---|
| 1 | x(i + 7) = (x(i + 6) + x(i))mod 2, 0 ≤ i < 120 |
| 2 | x(i + 7) = (x(i + 1) + x(i))mod 2, 0 ≤ i < 120 |
| 3 | x(i + 7) = (x(i + 4) + x(i))mod 2, 0 ≤ i < 120 |
| 4 | x(i + 7) = (x(i + 3) + x(i))mod 2, 0 ≤ i < 120 |
| 5 | x(i + 7) = (x(i + 6) + x(i + 5) + |
| | x(i + 4) + x(i))mod 2, 0 ≤ i < 120 |
| 6 | x(i + 7) = (x(i + 3) + x(i + 2) + |
| | x(i + 1) + x(i))mod 2, 0 ≤ i < 120 |
| 7 | x(i + 7) = (x(i + 6) + x(i + 5) + |
| | x(i + 2) + x(i))mod 2, 0 ≤ i < 120 |
| 8 | x(i + 7) = (x(i + 5) + x(i + 2) + |
| | x(i + 1) + x(i))mod 2, 0 ≤ i < 120 |
| 9 | x(i + 7) = (x(i + 5) + x(i + 4) + |
| | x(i + 3) + x(i))mod 2, 0 ≤ i < 120 |
| 10 | x(i + 7) = (x(i + 4) + x(i + 3) + |
| | x(i + 2) + x(i))mod 2, 0 ≤ i < 120 |
| 11 | x(i + 7) = (x(i + 6) + x(i + 4) + |
| | x(i + 2) + x(i))mod 2, 0 ≤ i < 120 |
| 12 | x(i + 7) = (x(i + 5) + x(i + 3) + |
| | x(i + 1) + x(i))mod 2, 0 ≤ i < 120 |
| 13 | x(i + 7) = (x(i + 6) + x(i + 4) + |
| | x(i + 1) + x(i))mod 2, 0 ≤ i < 120 |
| 14 | x(i + 7) = (x(i + 6) + x(i + 3) + |
| | x(i + 1) + x(i))mod 2, 0 ≤ i < 120 |
| 15 | x(i + 7) = (x(i + 5) + x(i + 4) + x(i + 3) + |
| | x(i + 2) + x(i + 1) + x(i))mod 2, 0 ≤ i < 120 |
| 16 | x(i + 7) = (x(i + 6) + x(i + 5) + x(i + 4) + |
| | x(i + 3) + x(i + 2) + x(i))mod 2, 0 ≤ i < 120 |
| 17 | x(i + 7) = (x(i + 6) + x(i + 5) + x(i + 3) + |
| | x(i + 2) + x(i + 1) + x(i))mod 2, 0 ≤ i < 120 |
| 18 | x(i + 7) = (x(i + 6) + x(i + 5) + x(i + 4) + |
| | x(i + 2) + x(i + 1) + x(i))mod 2, 0 ≤ i < 120 |

For yet another example, the sequence for PSS in the new SS/PBCH block has the same initial condition as the sequence for PSS in the legacy SS/PBCH block, but with a different generating function and a different cyclic shift, e.g.,

[x(6)x(5)x(4)x(3)x(2)x(1)x(0)]=[1 1 1 0 1 1 0], and

the generation function of the sequence for PSS in the new SS/PBCH block is based on one of the example in table 3 above, and

m=(n+Δ+43·N_{ID}⁽²⁾)mod 127.

In one instance of this example, Δ is a fixed number as 21. In another instance of this example, Δ is a fixed number as 22. In yet another instance of this example, Δ is a fixed number as 11. In yet another instance of this example, Δ is a fixed number as 10. In yet another instance of this example, Δ can be provided by the gNB using a higher layer parameter.

For yet another example, the sequence for PSS in the new SS/PBCH block has the same cyclic shift as the sequence for PSS in the legacy SS/PBCH block, but with a different generating function and a different initial condition, e.g.,

m=(n+43·N_{ID}⁽²⁾)mod 127,

[x(6)x(5)x(4)x(3)x(2)x(1)x(0)]≠[1 1 1 0 1 1 0], and

the generation function of the sequence for PSS in the new SS/PBCH block is based on one of the example in table 3 above.

Embodiments herein relate to a second component, SSS sequence design. As an embodiment, the sequence for SSS in the new SS/PBCH block can be different from the sequence for SSS in the legacy SS/PBCH block.

For one further consideration, the sequence for SSS in the new SS/PBCH block can be orthogonal or with low cross-correlation with the sequence for SSS in the legacy SS/PBCH block, e.g., such that the new SS/PBCH block may not have much impact to the SSS detection performance for the legacy SS/PBCH block.

For another further consideration, the sequence for SSS in the new SS/PBCH block can be based on two length-127 M-sequences, e.g.,

d_{SSS}^{new}(n)=[1−2·x₀((n+m₀)mod 127)]·[1−2·x₁((n+m₁)mod 127)],

where 0≤n<127.

In the following examples, N_{ID}⁽¹⁾ and N_{ID}⁽²⁾ are parts of the physical cell ID, e.g., N_{ID}^{cell}=3·N_{ID}⁽¹⁾+N_{ID}⁽²⁾, and N_{ID}^{cell} is the physical cell ID.

For one example, the sequence for SSS in the new SS/PBCH block has the same generating functions for x₀(i) and x₁(i) and initial conditions as the sequence for SSS in the legacy SS/PBCH block, but with different cyclic shift(s), e.g.,

x₀(i+7)=(x₀(i+4)+x₀(i))mod 2,

x₁(i+7)=(x₁(i+4)+x₁(i))mod 2,
where 0≤i<120,

[x₀(6)x₀(5)x₀(4)x₀(3)x₀(2)x₀(1)x₀(0)]=[0 0 0 0 0 0 1],

[x₁(6)x₁(5)x₁(4)x₁(3)x₁(2)x₁(1)x₁(0)]=[0 0 0 0 0 0 1],

m₀=15·└N_{ID}⁽¹⁾/112 ┘+5·N_{ID}⁽²⁾+Δ₀, and

m₁=(N_{ID}⁽¹⁾mod 112)+Δ₁.

In one instance of this example, Δ₀ is a fixed number such as 0. In another instance of this example, Δ₀ is a fixed number such as 2. In another instance of this example, Δ₀ is a fixed number such as 3. In yet another instance of this example, Δ₀ is a fixed number such as 7. In yet another instance of this example, Δ₀ is a fixed number such as 8. In yet another instance of this example, Δ₀ can be provided by the gNB using a higher layer parameter. In yet another instance of this example, Δ₁ is a fixed number such as 0. In yet another instance of this example, Δ₁ is a fixed number such as 7. In yet another instance of this example, Δ₁ is a fixed number such as 8. In yet another instance of this example, Δ₁ can be provided by the gNB using a higher layer parameter.

For another example, the sequence for SSS in the new SS/PBCH block has the same generating functions for x₀(i) and x₁(i) and cyclic shifts as the sequence for SSS in the legacy SS/PBCH block, but with different initial conditions, e.g.,

x₀(i+7)=(x₀(i+4)+x₀(i))mod 2,

x₁(i+7)=(x₁(i+4)+x₁(i))mod 2,
where 0≤i<120,

[x₀(6)x₀(5)x₀(4)x₀(3)x₀(2)x₀(1)x₀(0)]≠[0 0 0 0 0 0 1],

[x₁(6)x₁(5)x₁(4)x₁(3)x₁(2)x₁(1)x₁(0)]≠[0 0 0 0 0 0 1],

m₀=15·└N_{ID}⁽¹⁾/112┘+5·N_{ID}⁽²⁾, and

m₁=(N_{ID}⁽¹⁾mod 112).

For yet another example, the sequence for SSS in the new SS/PBCH block has the same initial conditions and cyclic shifts as the sequence for SSS in the legacy SS/PBCH block, but with different generating function(s) for x₀(i) and/or x₁(i), e.g.,

[x₀(6)x₀(5)x₀(4)x₀(3)x₀(2)x₀(1)x₀(0)]=[0 0 0 0 0 0 1],

[x₁(6)x₁(5)x₁(4)x₁(3)x₁(2)x₁(1)x₁(0)]=[0 0 0 0 0 0 1],

m₀=15·└N_{ID}⁽¹⁾/112┘+5·N_{ID}⁽²⁾,

m₁=(N_{ID}⁽¹⁾mod 112), and

the generation functions for x₀(i) and x₁(i) can be based on two of the examples in the above table 3.

For yet another example, the sequence for SSS in the new SS/PBCH block has the same initial conditions as the sequence for SSS in the legacy SS/PBCH block, but with different generating function(s) for x₀(i) and/or x₁(i) and different cyclic shifts, e.g.,

[x₀(6)x₀(5)x₀(4)x₀(3)x₀(2)x₀(1)x₀(0)]=[0 0 0 0 0 0 1],

[x₁(6)x₁(5)x₁(4)x₁(3)x₁(2)x₁(1)x₁(0)]=[0 0 0 0 0 0 1],

m₀=15·└N_{ID}⁽¹⁾/112┘+5·N_{ID}⁽²⁾+Δ₀,

m₁=(N_{ID}⁽¹⁾mod 112)+Δ₁, and

the generation functions for x₀(i) and x₁(i) can be based on two of the examples in the above table 3.

In one instance of this example, Δ₀ is a fixed number such as 0. In another instance of this example, Δ₀ is a fixed number such as 2. In another instance of this example, Δ₀ is a fixed number such as 3. In yet another instance of this example, Δ₀ is a fixed number such as 7. In yet another instance of this example, Δ₀ is a fixed number such as 8. In yet another instance of this example, Δ₀ can be provided by the gNB using a higher layer parameter.

In yet another instance of this example, Δ₁ is a fixed number such as 0. In yet another instance of this example, Δ₁ is a fixed number such as 7. In yet another instance of this example, Δ₁ is a fixed number such as 8. In yet another instance of this example, Δ₁ can be provided by the gNB using a higher layer parameter.

For yet another example, the sequence for SSS in the new SS/PBCH block has the same cyclic shifts as the sequence for SSS in the legacy SS/PBCH block, but with different generating function(s) for x₀(i) and/or x₁(i) and different initial conditions, e.g.,

[x₀(6)x₀(5)x₀(4)x₀(3)x₀(2)x₀(1)x₀(0)]≠[0 0 0 0 0 0 1],

[x₁(6)x₁(5)x₁(4)x₁(3)x₁(2)x₁(1)x₁(0)]≠[0 0 0 0 0 0 1],

m₀=15·└N_{ID}⁽¹⁾/112 ┘+5·N_{ID}⁽²⁾+Δ₀,

m₁=(N_{ID}⁽¹⁾mod 112),

and the generation functions for x₀(i) and x₁(i) can be based on two of the examples in the table 3 above.

Embodiments herein relate to a third component, DM-RS sequence design. In one embodiment, the sequence for DM-RS of PBCH in the new SS/PBCH block can be different from the sequence for DM-RS of PBCH in the legacy SS/PBCH block.

For one further consideration, the amount of timing information carried by the sequence of DM-RS of PBCH in the new SS/PBCH block is larger than the legacy SS/PBCH block, e.g., the number of DM-RS sequences in a given cell can be larger than 8.

In the following examples or instances of examples, N_{ID}^{cell} is the physical cell ID, L̅ₘₐₓ is the maximum number of candidate SS/PBCH blocks in a half frame, and ι̅_{SSB} is the candidate SS/PBCH block index with 0≤ι̅_{SSB}<L̅ₘₐₓ, i_{hf} is the half frame index (i_{hf}=0 refers to the first half frame in a frame and i_{hf}=1 refers to the second half frame in a frame), and i_{SFN} is the SFN, e.g. a number between 0 and 1023.

Embodiments herein relate to a sub-third component, PN sequence based DM-RS. For one sub-embodiment, the sequence for DM-RS of PBCH in the new SS/PBCH block can be based on the pseudo-random sequence given by

c(n)=(x₁(n+N_{C})+x₂(n+N_{C}))mod 2,

x₁(n+31)=(x₁(n+3)+x₁(n))mod 2,

x₂(n+31)=(x₂(n+3)+x₂(n+2)+x₂(n+1)+x₁(n))mod 2,

where N_{C}=1600, and the initial condition for x₁(n) is [x₁(30) . . . x₁(1)x₁(0)]=[0 . . . 0 1], and the initial condition for x₂(n) is denoted as cᵢₙᵢₜ=Σᵢ₌₀³⁰x₂(i)·2ⁱ.

Embodiments herein relate to a sub-third component, PN sequence based DM-RS. For one sub-embodiment, the initial condition cᵢₙᵢₜ is according to

cᵢₙᵢₜ=2¹¹(i_{timing}+1)(└N_{ID}^{cell}/4┘+1)+2⁶(i_{timing}+1)+(N_{ID}^{cell} mod 4),

where i_{timing} is a timing index, based on at least one of a candidate SS/PBCH block index, e.g., ι̅_{SSB}, a half frame index, e.g., i_{hf}, or a frame index, e.g., system frame number (SFN), i_{SFN}. In another example, the initial condition cᵢₙᵢₜ is according to

cᵢₙᵢₜ=²¹¹(i_{timing}+1)(N_{ID}^{cell}+1)+2⁶(i_{timing}+1)+N_{ID}^{cell},

where i_{timing} is a timing index, based on at least one of a candidate SS/PBCH block index, e.g., ι̅_{SSB}, a half frame index, e.g., i_{hf}, or a frame index, e.g., system frame number (SFN), i_{SFN}.

In yet another example, the initial condition cᵢₙᵢₜ is according to

cᵢₙᵢₜ=2¹¹(i_{timing}+1)(N_{ID}^{cell}+1)+2⁶(i_{timing}+1),

where i_{timing} is a timing index, e.g., 0≤i_{timing}<N_{timing}, based on at least one of a candidate SS/PBCH block index, e.g., ι̅_{SSB}, a half frame index, e.g., i_{hf}, or a frame index, e.g., system frame number (SFN), i_{SFN}.

Embodiments herein relate to another sub-third component, M sequence based DM-RS. For another sub-embodiment, the sequence for DM-RS of PBCH in the new SS/PBCH block can be based on a M-sequence, e.g., a length-127 M-sequence given by c(n)=1−2·x(m), where 0≤n<127.

In one example, the initial condition of x(i) can be fixed, e.g.

[x(6)x(5)x(4)x(3)x(2)x(1)x(0)]=[1 1 1 0 1 1 0], or

[x(6)x(5)x(4)x(3)x(2)x(1)x(0)]=[0 0 0 0 0 0 1].

In another example, the generation function of x(i) can be based on one of the examples in the above table. In yet another example, the cyclic shift of the M-sequence can be based on the timing information carried by the DM-RS sequence, e.g., i_{timing}. For instance, m=(n+θ·i_{timing})mod 127, wherein θ is an integer, e.g., θ is fixed as 1, or θ=└127/N_{timing} ┘, or 74=128/N_{timing}.

Embodiments herein relate to another sub-third component, gold sequence based DM-RS. For yet another sub-embodiment, the sequence for DM-RS of PBCH in the new SS/PBCH block can be based on a gold-sequence, e.g., a length-127 gold sequence given by

c(n)=[1−2·x₀((n+m₀)mod 127)]·[1−2·x₁((n+m₁)mod 127)],

where 0≤n<127.

In one example, the initial condition of x₀(i) and x₁(i) can be fixed, e.g.

[x₀(6)x₀(5)x₀(4)x₀(3)x₀(2)x₀(1)x₀(0)]=[0 0 0 0 0 0 1], and/or

[x₁(6)x₁(5)x₁(4)x₁(3)x₁(2)x₁(1)x₁(0)]=[0 0 0 0 0 0 1].

In another example, the generation function of x₀(i) and x₁(i) can be based on two of the example in the above table.

In yet another example, the cyclic shifts m₀ and/or m₁ can be based on the timing information carried by the DM-RS sequence (e.g., i_{timing}). For one instance, m₀=0, m₁=└127/N_{timing}┘·i_{timing}. For another instance, m₁=0, m₀=└127/N_{timing} ┘·i_{timing}. For yet another instance, m₀=0, m₁=128/N_{timing}·i_{timing}. For yet another instance, m₁=0, m₀=128/N_{timing}·i_{timing}. For yet another instance, m₀=└127/N_{timing}⁽¹⁾┘·i_{timing}⁽¹⁾, m₁=└127/N_{timing}⁽²⁾┘·i_{timing}⁽²⁾, wherein N_{timing}⁽¹⁾·N_{timing}⁽²⁾=N_{timing}, and 0≤i_{timing}⁽¹⁾<N_{timing}⁽¹⁾, 0≤i_{timing}⁽²⁾<N_{timing}⁽²⁾. For yet another instance, m₀=128/N_{timing}⁽¹⁾·i_{timing}⁽¹⁾, m₁=128/N_{timing}⁽²⁾·i_{timing}⁽²⁾, wherein N_{timing}⁽¹⁾·N_{timing}⁽²⁾=N_{timing}, and 0≤i_{timing}⁽¹⁾<N_{timing}⁽¹⁾, 0≤i_{timing}⁽²⁾<N_{timing}⁽²⁾.

Embodiments herein relate to another sub-third component, timing information details. In yet another sub-embodiment, the timing index, e.g., i_{timing} in the above instances can be according to one of the following examples and/or instances.

In one example, the timing index can be the same as the candidate SS/PBCH block index, e.g., i_{timing}=ι̅_{SSB}. In another example, the number of DM-RS sequences in a given cell can be up to 16, e.g., N_{timing}=16. In one instance of this example, for L̅ₘₐₓ=64, the timing information includes the four LSBs of the candidate SS/PBCH block index, e.g., i_{timing}=(ι̅_{SSB} mod 16). In another instance of this example, for L̅ₘₐₓ=20, the timing information includes the four LSBs of the candidate SS/PBCH block index, e.g., i_{timing}=(ι̅_{SSB} mod 16). In yet another instance of this example, for L̅ₘₐₓ=10, the timing information includes the candidate SS/PBCH block index, e.g., i_{timing}=ι̅_{SSB}. In yet another instance of this example, for L̅ₘₐₓ=8, the timing information includes the candidate SS/PBCH block index, e.g., i_{timing}=ι̅_{SSB}. In yet another instance of this example, for L̅ₘₐₓ=8, the timing information includes the candidate SS/PBCH block index and the half frame index, e.g., i_{timing}=ι̅_{SSB}+8·i_{hf}. In yet another instance of this example, for L̅ₘₐₓ=4, the timing information includes the candidate SS/PBCH block index, e.g., i_{timing}=ι̅_{SSB}. In yet another instance of this example, for L̅ₘₐₓ=4, the timing information includes the candidate SS/PBCH block index and the half frame index, e.g., i_{timing}=ι̅_{SSB}+4·i_{hf}. In yet another instance of this example, for L̅ₘₐₓ=4, the timing information includes the candidate SS/PBCH block index, the half frame index, and the first LSB of the SFN, e.g., i_{timing}=ι̅_{SSB}+4·i_{hf}+8 (i_{SFN} mod 2).

In yet another example, the number of DM-RS sequences in a given cell can be up to 32, e.g., N_{timing}=32. In one instance of this example, for L̅ₘₐₓ=64, the timing information includes the five LSBs of the candidate SS/PBCH block index, e.g., i_{timing}=(ι̅_{SSB} mod 32). In another instance of this example, for L̅ₘₐₓ=20, the timing information includes the candidate SS/PBCH block index, e.g., i_{timing}=ι̅_{SSB}. In yet another instance of this example, for L̅ₘₐₓ=10, the timing information includes the candidate SS/PBCH block index, e.g., i_{timing}=ι̅_{SSB}. In yet another instance of this example, for L̅ₘₐₓ=10, the timing information includes the candidate SS/PBCH block index and the half frame index, e.g., i_{timing}=ι̅_{SSB}+10·i_{hf}. In yet another instance of this example, for L̅ₘₐₓ=10, the timing information includes the candidate SS/PBCH block index and the half frame index, e.g., i_{timing}=ι̅_{SSB}+16·i_{hf}. In yet another instance of this example, for L̅ₘₐₓ=8, the timing information includes the candidate SS/PBCH block index, e.g., i_{timing}=ι̅_{SSB}. In yet another instance of this example, for L̅ₘₐₓ=8, the timing information includes the candidate SS/PBCH block index and the half frame index, e.g., i_{timing}=ι̅_{SSB}+8·i_{hf}. In yet another instance of this example, for L̅ₘₐₓ=8, the timing information includes the candidate SS/PBCH block index, the half frame index, and the first LSB of the SFN, e.g., i_{timing}=ι̅_{SSB}+8·i_{hf}+16 (i_{SFN} mod 2). In yet another instance of this example, for L̅ₘₐₓ=4, the timing information includes the candidate SS/PBCH block index, e.g., i_{timing}=ι̅_{SSB}. In yet another instance of this example, for L̅ₘₐₓ=4, the timing information includes the candidate SS/PBCH block index and the half frame index, e.g., i_{timing}=ι̅_{SSB}+4·i_{hf}. In yet another instance of this example, for L̅ₘₐₓ=4, the timing information includes the candidate SS/PBCH block index, the half frame index, and the two LSB of the SFN, e.g., i_{timing}=ι̅_{SSB}+4·i_{nf}+8 (i_{SFN} mod 4).

In yet another example, the number of DM-RS sequences in a given cell can be up to 64 (e.g., N_{timing}=64). In one instance of this example, for L̅ₘₐₓ=64, the timing information includes the candidate SS/PBCH block index, e.g., i_{timing}=ι̅_{SSB}. In another instance of this example, for L̅ₘₐₓ=20, the timing information includes the candidate SS/PBCH block index, e.g., i_{timing}=ι̅_{SSB}. In yet another instance of this example, for L̅ₘₐₓ=20, the timing information includes the candidate SS/PBCH block index and the half frame index, e.g., i_{timing}=ι̅_{SSB}+32·i_{hf}. In yet another instance of this example, for L̅ₘₐₓ=20, the timing information includes the candidate SS/PBCH block index and the half frame index, e.g., i_{timing}=ι̅_{SSB}+20·i_{hf}. In yet another instance of this example, for L̅ₘₐₓ=10, the timing information includes the candidate SS/PBCH block index, e.g., i_{timing}=ι̅_{SSB}. In yet another instance of this example, for L̅ₘₐₓ=10, the timing information includes the candidate SS/PBCH block index and the half frame index, e.g., i_{timing}=ι̅_{SSB}+16·i_{hf}. In yet another instance of this example, for L̅ₘₐₓ=10, the timing information includes the candidate SS/PBCH block index and the half frame index, e.g., i_{timing}=ι̅_{SSB}+10·i_{hf}. In yet another instance of this example, for L̅ₘₐₓ=10, the timing information includes the candidate SS/PBCH block index, the half frame index, and the first LSB of the SFN, e.g., i_{timing}=ι̅_{SSB}+16·i_{hf}+32·(i_{SFN} mod 2). In yet another instance of this example, for L̅ₘₐₓ=10, the timing information includes the candidate SS/PBCH block index, the half frame index, and the first LSB of the SFN, e.g., i_{timing}=ι̅_{SSB}+10·i_{hf}+20·(i_{SFN} mod 2). In yet another instance of this example, for L̅ₘₐₓ=8, the timing information includes the candidate SS/PBCH block index, e.g. i_{timing}=ι̅_{SSB}. In yet another instance of this example, for L̅ₘₐₓ=8, the timing information includes the candidate SS/PBCH block index and the half frame index, e.g., i_{timing}=ι̅_{SSB}+8·i_{hf}. In yet another instance of this example, for L̅ₘₐₓ=8, the timing information includes the candidate SS/PBCH block index, the half frame index, and the first two LSBs of the SFN, e.g., i_{timing}=ι̅_{SSB}+8·i_{hf}+16·(i_{SFN} mod 4). In yet another instance of this example, for L̅ₘₐₓ=4, the timing information includes the candidate SS/PBCH block index, e.g., i_{timing}=ι̅_{SSB}. In yet another instance of this example, for L̅ₘₐₓ=4, the timing information includes the candidate SS/PBCH block index and the half frame index, e.g., i_{timing}=ι̅_{SSB}+4·i_{hf}. In yet another instance of this example, for L̅ₘₐₓ=4, the timing information includes the candidate SS/PBCH block index, the half frame index, and the first three LSBs of the SFN, e.g., i_{timing}=ι̅_{SSB}+4·i_{hf}+8·(i_{SFN} mod 8).

In yet another example, the number of DM-RS sequences in a given cell can be up to 128, e.g., N_{timing}=128. In one instance of this example, for L̅ₘₐₓ=64, the timing information includes the candidate SS/PBCH block index, e.g., i_{timing}=ι̅_{SSB}. In another instance of this example, for L̅ₘₐₓ=64, the timing information includes the candidate SS/PBCH block index and the half frame index, e.g., i_{timing}=ι̅_{SSB}+64·i_{hf}. In yet another instance of this example, for L̅ₘₐₓ=20, the timing information includes the candidate SS/PBCH block index, e.g., i_{timing}=ι̅_{SSB}. In yet another instance of this example, for L̅ₘₐₓ=20, the timing information includes the candidate SS/PBCH block index and the half frame index, e.g., i_{timing}=ι̅_{SSB}+32·i_{hf}. In yet another instance of this example, for L̅ₘₐₓ=20, the timing information includes the candidate SS/PBCH block index and the half frame index, e.g., i_{timing}=ι̅_{SSB}+20·i_{hf}. In yet another instance of this example, for L̅ₘₐₓ=20, the timing information includes the candidate SS/PBCH block index, the half frame index, and the first LSB of the SFN, e.g., i_{timing}=ι̅_{SSB}+32·i_{hf}+64·(i_{SFN} mod 2). In yet another instance of this example, for L̅ₘₐₓ=20, the timing information includes the candidate SS/PBCH block index, the half frame index, and the first LSB of the SFN, e.g., i_{timing}=ι̅_{SSB}+20·i_{hf}+40·(i_{SFN} mod 2). In yet another instance of this example, for L̅ₘₐₓ=10, the timing information includes the candidate SS/PBCH block index, e.g., i_{timing}=ι̅_{SSB}. In yet another instance of this example, for L̅ₘₐₓ=10, the timing information includes the candidate SS/PBCH block index and the half frame index, e.g., i_{timing}=ι̅_{SSB}+16·i_{hf}. In yet another instance of this example, for L̅ₘₐₓ=10, the timing information includes the candidate SS/PBCH block index and the half frame index, e.g., i_{timing}=ι̅_{SSB}+10·i_{hf}. In yet another instance of this example, for L̅ₘₐₓ=10, the timing information includes the candidate SS/PBCH block index, the half frame index, and the first two LSBs of the SFN, e.g., i_{timing}=ι̅_{SSB}+16·i_{hf}+32·(i_{SFN} mod 4). In yet another instance of this example, for L̅ₘₐₓ=10, the timing information includes the candidate SS/PBCH block index, the half frame index, and the first two LSBs of the SFN, e.g., i_{timing}=ι̅_{SSB}+10·i_{hf}+20·(i_{SFN} mod 4). In yet another instance of this example, for L̅ₘₐₓ=8, the timing information includes the candidate SS/PBCH block index, e.g., i_{timing}=ι̅_{SSB}. In yet another instance of this example, for L̅ₘₐₓ=8, the timing information includes the candidate SS/PBCH block index and the half frame index, e.g., i_{timing}=ι̅_{SSB}+8·i_{hf}. In yet another instance of this example, for L̅ₘₐₓ=8, the timing information includes the candidate SS/PBCH block index, the half frame index, and the first three LSBs of the SFN, e.g., i_{timing}=ι̅_{SSB}+8·i_{hf}+16·(i sFN mod 8). In yet another instance of this example, for L̅ₘₐₓ=4, the timing information includes the candidate SS/PBCH block index, e.g., i_{timing}=ι̅_{SSB}. In yet another instance of this example, for L̅ₘₐₓ=4, the timing information includes the candidate SS/PBCH block index and the half frame index, e.g., i_{timing}=ι̅_{SSB}+4·i_{hf}. In yet another instance of this example, for L̅ₘₐₓ=4, the timing information includes the candidate SS/PBCH block index, the half frame index, and the first four LSBs of the SFN, e.g., i_{timing}=ι̅_{SSB}+4·i_{hf}+8·(i_{SFN} mod 16).

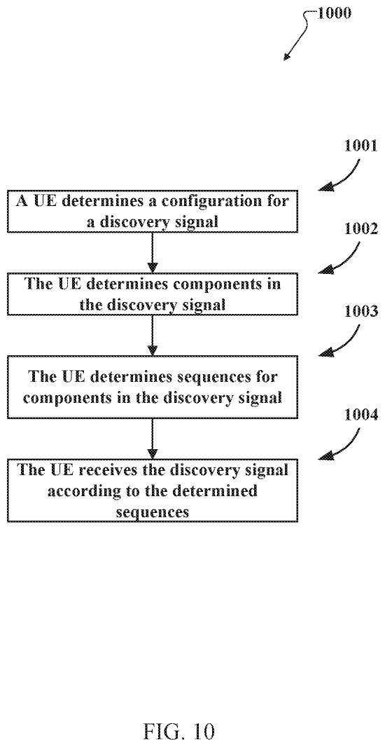

FIG. 10 illustrates a flowchart of an example process 1000 for a UE receiving the discovery signal according to various embodiments of the present disclosure. For example, process 1000 may be implemented by the UE 116. The process 1000 is for illustration only and other embodiments can be used without departing from the scope of the present disclosure.

The UE 116 determines a configuration for a discovery signal in step 1001 and then determines components in the discovery signal based on the configuration in step 1002. The UE 116 determines sequences of the components in the discovery signal in step 1003 and receives the discovery signal according to the determined sequences in step 1004.

Embodiments herein relate to the reception and measurement of a discovery signal. Reception of a discovery signal can include a configuration for the reception of a discovery signal and a UE procedure for the reception of a discovery signal. Measurement of a discovery signal can include configuration for measurement of a discovery signal, a metric for the measurement of a discovery signal, and a UE procedure for measurement of a discovery signal.

In one embodiment of a configuration for the reception of a discovery signal, a set of configurations for the discovery signal can be provided by the gNB 102, e.g., by higher layer parameters.

In one example, the set of configurations can include at least one numerology for the discovery signal. For one instance, the at least one numerology includes a subcarrier spacing. For another instance, the at least one numerology includes a cyclic prefix value.

In one sub-example, the components in the discovery signal can be configured with the same numerology, e.g., a single common numerology. In another sub-example, the components in the discovery signal can have more than one numerology. For instance, some component(s) can be configured with a first numerology and some other component(s) can be configured with a second numerology.

In another example, the set of configurations can include a type for the discovery signal. For one instance, the type for the discovery signal is applicable to all components included in the discovery signal. For another instance, the type for the discovery signal is applicable to a part of the components included in the discovery signal, e.g., for CSI-RS.

In one sub-example, the type for the discovery signal can be configured as periodic. The discovery signal periodically shows up in every period. In another sub-example, the type for the discovery signal can be configured as semi-persistent. The discovery signal shows up with a configured interval within a configured duration. In yet another sub-example, the type for the discovery signal can be configured as aperiodic. The discovery signal shows up within at least one instance. For instance, the number of instances that the discovery signal shows up can be configured by a higher layer parameter.

In yet another example, the set of configurations can include time domain information for the discovery signal. In one sub-example, the time domain information for the discovery signal includes at least one time domain periodicity.

For one instance, the components in the discovery signal can be configured with the same periodicity, e.g., a single common periodicity, and all the components show up in every period.

For another instance, the components in the discovery signal can have more than one periodicity. For instance, some component(s) can be configured with a first periodicity and some other component(s) can be configured with a second periodicity. Not all the components included in the discovery signal show up in every period, e.g., the components with a larger value of periodicity may not show up in every period for the components with a smaller value of periodicity.

In another sub-example, the time domain information for the discovery signal includes a time domain pattern within the period for the resources mapped for the discovery signal. For one instance, the time domain pattern can be according to a set of starting symbols or slots for the components in the discovery signal, wherein the time domain pattern for the starting symbols or slots can be determined as N_{offset}+i·Nᵢₙₜₑᵣᵥₐₗ, eg, N_{offset} is the time domain offset in symbol or slot, Nᵢₙₜₑᵣᵥₐₗ is the time domain interval between neighboring occasions for the discovery signal in symbol or slot, and i is the index of the occasion for the discovery signal.

For another instance, the time domain pattern can be a bitmap indicating which index of the instances is transmitted. The length of the bitmap can be the same as the maximum number of SS/PBCH block indexes in the cell. A bit taking value of 1 indicates the corresponding discovery signal, e.g., SS/PBCH block associated with other components in the discovery signal, is transmitted, and a bit taking value of 0 indicates the corresponding discovery signal, e.g., SS/PBCH block associated with other components in the discovery signal, is not transmitted.

For yet another instance, the time domain pattern can include a time domain resource for one instance of a discovery signal, wherein the configuration can include a starting symbol or slot. For yet another instance, the time domain pattern can include a time domain resource for one instance of a discovery signal, wherein configuration can include an index of the one instance of the discovery signal.

In yet another example, the set of configurations can include frequency domain information for the discovery signal. For one instance, the frequency domain information for the discovery signal can include an indication of the frequency domain location of a SS/PBCH block included in the discovery signal.

For one sub-instance, the frequency domain location of a SS/PBCH block included in the discovery signal may not be aligned with the frequencies defined by the synchronization raster entries, e.g., the GSCN values defined for the initial cell search. For another sub-instance, the frequency domain location of a SS/PBCH block included in the discovery signal may not fall into a range around the frequencies defined by the synchronization raster entries, e.g., the GSCN values defined for the initial cell search. For another instance, the frequency domain information for the discovery signal can include an indication of the frequency domain location of a CSI-RS included in the discovery signal, e.g., the starting RB. For yet another instance, the frequency domain information for the discovery signal can include an indication of the frequency domain bandwidth of a CSI-RS included in the discovery signal, e.g., as a number of RB s. For yet another instance, the frequency domain information for the discovery signal can include an indication of the RE location within a RB for a CSI-RS included in the discovery signal. For yet another instance, the frequency domain information for the discovery signal can include an indication of the density of REs for a CSI-RS included in the discovery signal, e.g., a number of REs in each RB.

In yet another example, the set of configurations can include antenna port information for the discovery signal. For one instance, the antenna port for the discovery signal can be a common one for all the components included in the discovery signal. For another instance, the antenna port for the discovery signal can be applicable to a part of the components included in the discovery signal, e.g., CSI-RS.

In yet another example, the set of configurations can include TCI state information and/or QCL assumption information for the discovery signal. For one instance, the TCI state information and/or QCL assumption information for the discovery signal can be common for all components included in the discovery signal. For another instance, the TCI state information and/or QCL assumption information for the discovery signal can be applicable to a part of the components included in the discovery signal, e.g., CSI-RS. For one instance, the RS source of the TCI state information and/or QCL assumption information for the discovery signal can be from a carrier not including the discovery signal. For one sub-instance, the RS source can be from the carrier that provides the set of configurations. For one instance, the TCI state information and/or QCL assumption information for the discovery signal could be whether the RS source of the TCI state information and/or QCL assumption information for the discovery signal can be from a carrier not including the discovery signal.

In yet another example, the set of configurations can include power information for the discovery signal. For one instance, the power information for the discovery signal can be configured as a common one for all the components included in the discovery signal. For another instance, a first power information can be configured for a first part of the components included in the discovery signal, e.g., SS/PBCH block, and second power information can be configured for a second part of the components included in the discovery signal, e.g., CSI-RS. For one instance, the power information for the discovery signal or components in the discovery signal can be an absolute power value. For one instance, the power information for the discovery signal or components in the discovery signal can be a relative or differentiated power value compared with a reference. For one sub-instance, the reference can be SS/PBCH block in the discovery signal. For another sub-instance, the reference can be SS/PBCH block in the PCell.

In yet another example, the set of configurations can include information on round trip delays between two carriers. For instance, the information of round trip delay is between a carrier providing the set of configurations and another carrier including the discovery signal.

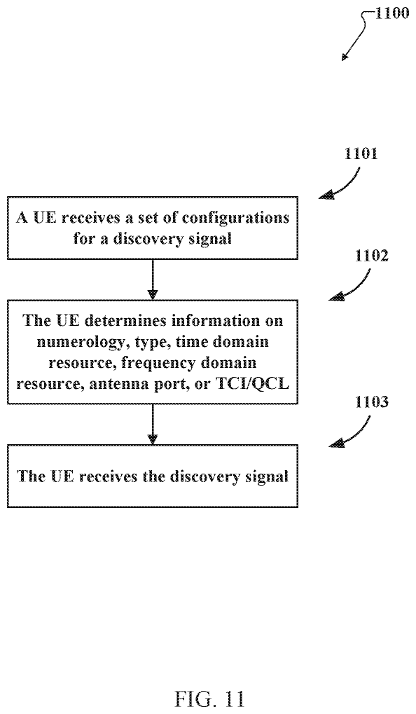

FIG. 11 illustrates a flowchart of an example process 1100 for receiving a discovery signal for a UE according to various embodiments of the present disclosure. For example, process 1100 may be implemented by the UE 116. The process 1100 is for illustration only and other embodiments can be used without departing from the scope of the present disclosure.

The UE 116 can receive a set of configurations for a discovery signal in step 1101 and then determines information for the discovery signal, including at least one of numerology, a type of the signal/channel, information on the time domain resources, information on the frequency domain resources, antenna port, TCI state or QCL assumption, or timing information in step 1102. The UE 116 can receive the discovery signal based on the information for the discovery signal in step 1103.

For one example, the UE 116 could further determine whether the information on timing, e.g., the round trip delay between two carriers, satisfies a requirement before receiving the discovery signal. The UE 116 may receive the discovery signal upon determining the information on timing, e.g., the round trip delay between two carriers, satisfies the requirement.

For another example, the UE 116 could further determine whether the information on power, e.g., the reception power difference between two carriers, satisfies a requirement before receiving the discovery signal. The UE may receive the discovery signal upon determining the information on power, e.g., the reception power difference between two carriers, satisfies the requirement.

For yet another example, the UE 116 could further determine whether the information on TCI state and/or QCL assumption, e.g., determining TCI state and/or QCL assumption on one carrier from another carrier, satisfies a requirement before receiving the discovery signal. The UE 116 may receive the discovery signal upon determining the information on the TCI state and/or QCL assumption that satisfies the requirement.

For yet another example, the UE 116 could further determine whether the information on the frequency domain, e.g., frequency differences between two carriers, satisfies a requirement before receiving the discovery signal. The UE 116 may receive the discovery signal upon determining the information on the frequency domain, e.g., frequency differences between two carriers, satisfies the requirement.

For one example, the UE 116 can determine a time domain pattern of the discovery signal based on whether the RS as a source of the TCI state and/or QCL assumption for the discovery signal is within the same carrier as the discovery signal or not, e.g., whether the TCI state and/or QCL assumption is within the same carrier or across carriers. For instance, if the RS as a source of the TCI state and/or QCL assumption for the discovery signal is within the same carrier as the discovery signal, the UE 116 can be indicated with a single instance of the discovery signal in the time domain; if the RS as a source of the TCI state and/or QCL assumption for the discovery signal is not within the same carrier as the discovery signal, the UE 116 can be indicated with a burst of instances of the discovery signal in the time domain.

For another example, the UE 116 can determine a time domain pattern of the discovery signal based on whether the UE can use a RS from a different carrier as the source of the TCI state and/or QCL assumption for the discovery signal. For instance, if the UE 116 can use a RS from a different carrier as the source of the TCI state and/or QCL assumption for the discovery signal, the UE 116 can be indicated with a single instance of the discovery signal in the time domain; if the UE 116 is not able to use a RS from a different carrier as the source of the TCI state and/or QCL assumption for the discovery signal, the UE 116 can be indicated with a burst of instances of the discovery signal in the time domain.

For yet another example, the UE 116 can determine a time domain pattern of the discovery signal based on whether the UE is provided with the TCI state and/or QCL assumption for the discovery signal. For instance, if the UE 116 is provided with the TCI state and/or QCL assumption for the discovery signal, the UE 116 can be indicated with a single instance of the discovery signal in the time domain; if the UE 116 is not provided with the TCI state and/or QCL assumption for the discovery signal, the UE 116 can be indicated with a burst of instances of the discovery signal in the time domain.

In one embodiment, a set of configurations for discovery signal can be provided by the gNB 102, e.g., by higher layer parameters, for measurement purposes, e.g., at least one of RRM, RLM, or beam management.

In one example, the set of configurations can include at least one numerology for the discovery signal to be measured. For one instance, the at least one numerology includes a subcarrier spacing. For another instance, the at least one numerology includes a cyclic prefix value.

In another example, the set of configurations can include a type for the discovery signal to be measured. For one instance, the type for the discovery signal is applicable to all components included in the discovery signal. For another instance, the type for the discovery signal is applicable to a part of the components included in the discovery signal, e.g., for CSI-RS. For yet another instance, the type for the discovery signal can be at least one from periodic, semi-persistent, or aperiodic.

In yet another example, the set of configurations can include time domain information for the discovery signal to be measured.

In one sub-example, the time domain information for the discovery signal includes at least one time domain periodicity. For one instance, the components in the discovery signal can be configured with the same periodicity, e.g., a single common periodicity, and all the components show up in every period. For another instance, the components in the discovery signal can have more than one periodicity. For instance, some component(s) can be configured with a first periodicity and some other component(s) can be configured with a second periodicity. Not all the components included in the discovery signal show up in every period, e.g., the components with the larger value of periodicity may not show up in every period for the components with a smaller value of periodicity.

In another sub-example, the time domain information for the discovery signal includes a time domain pattern within the period for the discovery signal to be measured. For one instance, the time domain pattern can be according to a set of starting symbols or slots for the components in the discovery signal, wherein the time domain pattern for the starting symbols or slots can be determined as N_{offset}+i·Nᵢₙₜₑᵣᵥₐₗ, e.g., N_{offset} is the time domain offset in symbol or slot, Nᵢₙₜₑᵣᵥₐₗ is the time domain interval between neighboring occasions for a discovery signal in a symbol or slot, and i is the index of the occasion for the discovery signal. For another instance, the time domain pattern can be a bitmap indicating which index of the instances is measured. The length of the bitmap can be the same as the maximum number of SS/PBCH block indexes in the cell. A bit taking value of 1 indicates the corresponding discovery signal, e.g., SS/PBCH block associated with other components in the discovery signal, is to be measured, and a bit taking value of 0 indicates the corresponding discovery signal, e.g., SS/PBCH block associated with other components in the discovery signal, is not measured. For yet another instance, the time domain pattern can include a time domain resource for one instance of a discovery signal, wherein the configuration can include a starting symbol or slot. For yet another instance, the time domain pattern can include a time domain resource for one instance of a discovery signal, wherein configuration can include an index of the one instance of the discovery signal.

In yet another sub-example, the time domain information for the discovery signal to be measured includes a time domain measurement window. For one instance, the time domain measurement window can be determined based on a periodicity included in the time domain information for the discovery signal to be measured. For another instance, the time domain measurement window can be determined based on an offset, e.g., comparing with the starting of the period, included in the time domain information for the discovery signal to be measured. For yet another instance, the time domain measurement window can be determined based on a duration included in the time domain information for the discovery signal to be measured.

In yet another example, the set of configurations can include frequency domain information for the discovery signal to be measured. For one instance, the frequency domain information for the discovery signal can include an indication of the frequency domain location of a SS/PBCH block included in the discovery signal. For one sub-instance, the frequency domain location of a SS/PBCH block included in the discovery signal may not be aligned with the frequencies defined by the synchronization raster entries, e.g., the GSCN values defined for the initial cell search. For another sub-instance, the frequency domain location of a SS/PBCH block included in the discovery signal may not fall into a range around the frequencies defined by the synchronization raster entries, e.g., the GSCN values defined for the initial cell search. For another instance, the frequency domain information for the discovery signal can include an indication of the frequency domain location of a CSI-RS included in the discovery signal, e.g., the starting RB. For yet another instance, the frequency domain information for the discovery signal can include an indication of the frequency domain bandwidth of a CSI-RS included in the discovery signal, e.g., as a number of RBs. For yet another instance, the frequency domain information for the discovery signal can include an indication of the RE location within a RB for a CSI-RS included in the discovery signal. For yet another instance, the frequency domain information for the discovery signal can include an indication of the density of REs for a CSI-RS included in the discovery signal, e.g., a number of REs in each RB.

In yet another example, the set of configurations can include antenna port information for the discovery signal to be measured. For one instance, the antenna port for the discovery signal can be a common one for all the components included in the discovery signal. For another instance, the antenna port for the discovery signal can be applicable to a part of the components included in the discovery signal, e.g., CSI-RS.

In yet another example, the set of configurations can include TCI state information and/or QCL assumption information for the discovery signal to be measured. For one instance, the TCI state information and/or QCL assumption information for the discovery signal can be common for all components included in the discovery signal. For another instance, the TCI state information and/or QCL assumption information for the discovery signal can be applicable to a part of the components included in the discovery signal, e.g., CSI-RS. For one instance, the RS source of the TCI state information and/or QCL assumption information for the discovery signal can be from a carrier not including the discovery signal. For one sub-instance, the RS source can be from the carrier that provides the set of configurations. For one instance, the TCI state information and/or QCL assumption information for the discovery signal could be whether the RS source of the TCI state information and/or QCL assumption information for the discovery signal can be from a carrier not including the discovery signal.

In yet another example, the set of configurations can include power information for the discovery signal to be measured. For one instance, the power information for the discovery signal can be configured as a common one for all the components included in the discovery signal. For another instance, a first power information can be configured for a first part of the components included in the discovery signal, e.g., SS/PBCH block, and second power information can be configured for a second part of the components included in the discovery signal, e.g., CSI-RS. For one instance, the power information for the discovery signal or components in the discovery signal can be an absolute power value. For one instance, the power information for the discovery signal or components in the discovery signal can be a relative or differentiated power value compared with a reference. For one sub-instance, the reference can be SS/PBCH block in the discovery signal. For another sub-instance, the reference can be SS/PBCH block in the PCell.

In yet another example, the set of configurations can include information on round trip delays between two carriers. For instance, the information of round-trip delay is between a carrier providing the set of configurations and another carrier including the discovery signal to be measured.

In one embodiment, at least one new metric can be support for measurement based on the discovery signal. In one example, the at least one new metric can be a RSRP based on the discovery signal, e.g., DS-RSRP. For one instance, the DS-RSRP can be defined as the linear average over the power contributions of the resource elements that carry at least one signal in the discovery signal. For one sub-instance, the at least one signal includes SSS in the discovery signal. For another sub-instance, the at least one signal includes PSS in the discovery signal. For yet another sub-instance, the at least one signal includes DM-RS of PBCH in the discovery signal. For yet another sub-instance, the at least one signal includes CSI-RS in the discovery signal, e.g., the CSI-RS can be TRS or CSI-RS for measurement purposes. For one further consideration, the CSI-RS can be included if it is QCLed with another signal (e.g., SSS, PSS, or DM-RS of PBCH) in the discovery signal. For another instance, the measurement time for DS-RSRP can be confined within the discovery signal time domain measurement window, as described in the disclosure. For yet another instance, DS-RSRP can be measured among the signals corresponding to the same SS/PBCH block index and/or the same physical layer cell identity.

In another example, the at least one new metric can be a RSRQ based on the discovery signal, e.g., DS-RSRQ. For one instance, the DS-RSRQ can be defined as the ratio of N*DS-RSRQ/DS-RSSI, where N is the number of RBs in the DS-RSSI measurement bandwidth. For another instance, the measurement in the numerator and denominator can be performed over the same set of RBs. For yet another instance, DS-RSSI can be defined as the linear average of the total received power observed in OFDM symbols of measurement time resources and over N RBs in the measurement bandwidth. For yet another instance, the OFDM symbols in the slot(s) for measurement time resources of DS-RSSI can be the ones provided by a higher layer. For yet another instance, the slots including the OFDM symbols for DS-RSSI measurement can be provided by a higher layer. For yet another instance, if a measurement gap is provided, the DS-RSSI measurement can be according to the slots overlapping with the measurement gap. For yet another instance, the DS-RSSI measurement can be according to the slots confined within the discovery signal time domain measurement window, as described in the disclosure. For yet another instance, DS-RSRQ can be measured among the signals corresponding to the same SS/PBCH block index and/or the same physical layer cell identity.

In yet another example, the at least one new metric can be a SINR based on the discovery signal, e.g., DS-SINR. For one instance, the DS-SINR can be defined as the linear average over the power contribution of the resource elements carrying at least one signal in the discovery signal divided by the linear average of the noise and interference power contribution. For one sub-instance, the at least one signal includes SSS in the discovery signal. For another sub-instance, the at least one signal includes PSS in the discovery signal. For yet another sub-instance, the at least one signal includes DM-RS of PBCH in the discovery signal. For yet another sub-instance, the at least one signal includes CSI-RS in the discovery signal, e.g., the CSI-RS can be TRS or CSI-RS for measurement purposes. For one further consideration, the CSI-RS can be included if it is QCLed with another signal, e.g., SSS, PSS, or DM-RS of PBCH, in the discovery signal. For another instance, the measurement time for DS-SINR can be confined within the discovery signal time domain measurement window, as described in the disclosure. For yet another instance, DS-SINR can be measured among the signals corresponding to the same SS/PBCH block index and/or the same physical layer cell identity.

In another example, the at least one new metric can be a RSRPB based on the discovery signal, e.g., DS-RSRPB. For one instance, the DS-RSRPB can be defined as the linear average over the power contributions of the resource elements that carry at least one signal in the discovery signal. For one sub-instance, the at least one signal includes SSS in the discovery signal. For another sub-instance, the at least one signal includes PSS in the discovery signal. For yet another sub-instance, the at least one signal includes DM-RS of PBCH in the discovery signal. For yet another sub-instance, the at least one signal includes CSI-RS in the discovery signal, e.g., the CSI-RS can be TRS or CSI-RS for measurement purposes. For one further consideration, the CSI-RS can be included if it is QCLed with another signal, e.g., SSS, PSS, or DM-RS of PBCH, in the discovery signal. For another instance, the measurement time for DS-RSRPB can be confined within the discovery signal time domain measurement window, as described in the disclosure. For yet another instance, DS-RSRPB can be measured among the signals corresponding to the same SS/PBCH block index and/or the same physical layer cell identity.

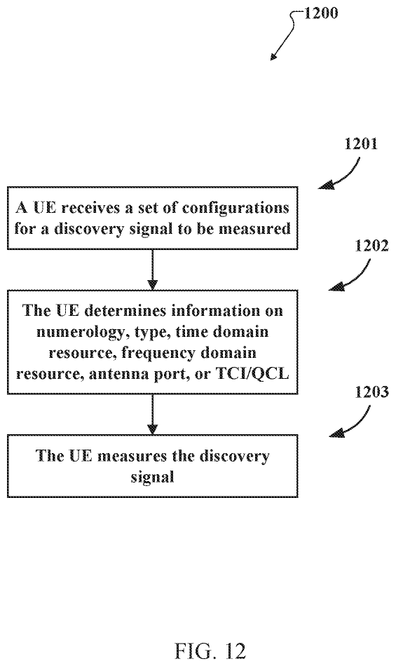

FIG. 12 illustrates a flowchart of an example process 1200 receiving a discovery signal for a UE according to various embodiments of the present disclosure. For example, process 1200 may be implemented by the UE 116. The process 1200 is for illustration only and other embodiments can be used without departing from the scope of the present disclosure.

In one embodiment, an example UE procedure for receiving a discovery signal is shown in FIG. 12. The UE 116 can receive a set of configurations for a discovery signal to be measured in step 1201 and then determines information for the discovery signal, including at least one of a numerology, a type of the signal/channel, information on the time domain resources, information on the frequency domain resources, antenna port, TCI state or QCL assumption, or timing information in step 1202. The UE 116 can measure the discovery signal based on the information for the discovery signal in step 1203.

For one example, the UE 116 could further determine whether the information on timing, e.g., the round trip delay between two carriers, satisfies a requirement before measuring the discovery signal. The UE 116 may measure the discovery signal upon determining the information on timing, e.g., the round trip delay between two carriers, satisfies the requirement. For another example, the UE 116 could further determine whether the information on power, e.g., the reception power difference between two carriers, satisfies a requirement before measuring the discovery signal. The UE 116 may measure the discovery signal upon determining the information on power, e.g., the reception power difference between two carriers, satisfies the requirement. For yet another example, the UE 116 could further determine whether the information on TCI state and/or QCL assumption, e.g., determining TCI state and/or QCL assumption on one carrier from another carrier, satisfies a requirement before measuring the discovery signal. The UE 116 may measure the discovery signal upon determining the information on the TCI state and/or QCL assumption satisfies the requirement.

For yet another example, the UE 116 could further determine whether the information on the frequency domain, e.g., frequency differences between two carriers, satisfies a requirement before measuring the discovery signal. The UE 116 may measure the discovery signal upon determining the information on the frequency domain, e.g., frequency differences between two carriers, satisfies the requirement.

For one example, the UE 116 can determine a time domain pattern of the discovery signal to measure based on whether the RS as a source of the TCI state and/or QCL assumption for the discovery signal is within the same carrier as the discovery signal or not, e.g., whether the TCI state and/or QCL assumption is within the same carrier or across carriers. For instance, if the RS as a source of the TCI state and/or QCL assumption for the discovery signal is within the same carrier as the discovery signal, the UE 116 can be indicated with a single instance of the discovery signal in the time domain. If the RS as a source of the TCI state and/or QCL assumption for the discovery signal is not within the same carrier as the discovery signal, the UE 116 can be indicated with a burst of instances of the discovery signal in the time domain.

For another example, the UE 116 can determine a time domain pattern of the discovery signal to measure based on whether the UE can use a RS from a different carrier as the source of the TCI state and/or QCL assumption for the discovery signal. For instance, if the UE 116 can use a RS from a different carrier as the source of the TCI state and/or QCL assumption for the discovery signal, the UE 116 can be indicated with a single instance of the discovery signal in the time domain; if the UE 116 is not able to use a RS from a different carrier as the source of the TCI state and/or QCL assumption for the discovery signal, the UE 116 can be indicated with a burst of instances of the discovery signal in the time domain.

For yet another example, the UE 116 can determine a time domain pattern of the discovery signal to measure based on whether the UE 116 is provided with the TCI state and/or QCL assumption for the discovery signal. For instance, if the UE is provided with the TCI state and/or QCL assumption for the discovery signal, the UE 116 can be indicated with a single instance of the discovery signal in the time domain; if the UE 116 is not provided with the TCI state and/or QCL assumption for the discovery signal, the UE 116 can be indicated with a burst of instances of the discovery signal in the time domain.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a transceiver configured to receive a set of configurations for a discovery signal, wherein the discovery signal includes a primary synchronization signal (PSS) and a secondary synchronization signal (SSS); and
a processor operably coupled to the transceiver, the processor configured to:
determine a frequency location of the discovery signal;
determine a time domain information of the discovery signal;
determine a subcarrier spacing of the discovery signal; and
determine a quasi-co-location (QCL) assumption of the discovery signal,
wherein the transceiver is further configured to receive the discovery signal from a secondary cell (SCell) based on the frequency location, the time domain information, the subcarrier spacing, and the QCL assumption of the discovery signal.

2. The UE of claim 1, wherein:
the PSS and the SSS are mapped to two consecutive orthogonal frequency division multiplexing (OFDM) symbols, respectively;
the PSS is mapped to a first OFDM symbol within the two consecutive OFDM symbols; and
the SSS is mapped to a second OFDM symbol within the two consecutive OFDM symbols.

3. The UE of claim 1, wherein the discovery signal further includes a demodulation reference signal (DM-RS) of a physical broadcast channel (PBCH) or a channel state information reference signal (CSI-RS).

4. The UE of claim 1, wherein the QCL assumption indicates that the discovery signal is QCLed with a synchronization signals and physical broadcast channel (SS/PBCH) block from a primary cell (PCell).

5. The UE of claim 1, wherein the time domain information includes a periodicity of transmission occasions for the discovery signal and a time domain pattern of the discovery signal in each transmission occasion.

6. The UE of claim 1, wherein the processor is further configured to determine a set of configurations for radio resource management (RRM) measurement based on the discovery signal.

7. The UE of claim 6, wherein the processor is further configured to determine a reference signal receive power (RSRP) or a reference signal receive quality (RSRQ) based on the discovery signal.

8. A base station (BS) in a wireless communication system, the BS comprising:
a processor configured to:
determine a frequency location of a discovery signal;
determine a time domain information of the discovery signal;
determine a subcarrier spacing of the discovery signal; and
determine a quasi-co-location (QCL) assumption of the discovery signal; and
a transceiver operably coupled to the processor, the transceiver configured to:
transmit a set of configurations for the discovery signal, wherein the discovery signal includes a primary synchronization signal (PSS) and a secondary synchronization signal (SSS); and
transmit the discovery signal on a secondary cell (SCell) based on the frequency location, the time domain information, the subcarrier spacing, and the QCL assumption of the discovery signal.

9. The BS of claim 8, wherein:
the PSS and the SSS are mapped to two consecutive orthogonal frequency division multiplexing (OFDM) symbols, respectively;
the PSS is mapped to a first OFDM symbol within the two consecutive OFDM symbols; and
the SSS is mapped to a second OFDM symbol within the two consecutive OFDM symbols.

10. The BS of claim 8, wherein the discovery signal further includes a demodulation reference signal (DM-RS) of a physical broadcast channel (PBCH) or a channel state information reference signal (CSI-RS).

11. The BS of claim 8, wherein the QCL assumption indicates that the discovery signal is QCLed with a synchronization signals and physical broadcast channel (SS/PBCH) block from a primary cell (PCell).

12. The BS of claim 8, wherein the time domain information includes a periodicity of transmission occasions for the discovery signal and a time domain pattern of the discovery signal in each transmission occasion.

13. The BS of claim 8, wherein a set of configurations for radio resource management (RRM) measurement are based on the discovery signal.

14. The BS of claim 13, wherein a reference signal receive power (RSRP) or a reference signal receive quality (RSRQ) is based on the discovery signal.

15. A method of a user equipment (UE) in a wireless communication system, the method comprising:
receiving a set of configurations for a discovery signal, wherein the discovery signal includes a primary synchronization signal (PSS) and a secondary synchronization signal (SSS);
determining a frequency location of the discovery signal;
determining a time domain information of the discovery signal;
determining a subcarrier spacing of the discovery signal;
determining a quasi-co-location (QCL) assumption of the discovery signal; and
receiving the discovery signal from a secondary cell (SCell) based on the frequency location, the time domain information, the subcarrier spacing, and the QCL assumption of the discovery signal.

16. The method of claim 15, wherein:
the PSS and the SSS are mapped to two consecutive orthogonal frequency division multiplexing (OFDM) symbols, respectively;
the PSS is mapped to a first OFDM symbol within the two consecutive OFDM symbols; and
the SSS is mapped to a second OFDM symbol within the two consecutive OFDM symbols.

17. The method of claim 15, wherein the discovery signal further includes a demodulation reference signal (DM-RS) of a physical broadcast channel (PBCH) or a channel state information reference signal (CSI-RS).

18. The method of claim 15, wherein the QCL assumption indicates that the discovery signal is QCLed with a synchronization signals and physical broadcast channel (SS/PBCH) block from a primary cell (PCell).

19. The method of claim 15, wherein the time domain information includes a periodicity of transmission occasions for the discovery signal and a time domain pattern of the discovery signal in each transmission occasion.

20. The method of claim 15, further comprising:
determining a set of configurations for radio resource management (RRM) measurement based on the discovery signal; and
determining at least a reference signal receive power (RSRP) or a reference signal receive quality (RSRQ) based on the discovery signal.
